(19) United States
(12) Patent Application Publication
(10) Pub. No.: US 2024/0353603 A1
(43) Pub. Date: Oct. 24, 2024

(54) LIQUID CRYSTALLINE COMPOSITION, CURED PRODUCT, OPTICALLY ANISOTROPIC LAYER, OPTICAL ELEMENT, AND LIGHT GUIDE ELEMENT

(71) Applicant: FUJIFILM Corporation, Tokyo (JP)

(72) Inventors: Yuki FUKUSHIMA, Minamiashigara-shi (JP); Keisuke KODAMA, Minamiashigara-shi (JP); Shunya KATOH, Minamiashigara-shi (JP); Hideki KANEIWA, Minamiashigara-shi (JP)

(73) Assignee: FUJIFILM Corporation, Tokyo (JP)

(21) Appl. No.: 18/755,881

(22) Filed: Jun. 27, 2024

Related U.S. Application Data
(63) Continuation of application No. PCT/JP2022/046330, filed on Dec. 16, 2022.

(30) Foreign Application Priority Data
Dec. 28, 2021 (JP) 2021-214383

(51) Int. Cl. G02B 5/30; C08F 22/20; C08F 22/24; C08K 5/1545; C08K 5/17; C09K 19/04; C09K 19/38; C09K 19/54

(52) U.S. Cl. CPC G02B 5/3016; C08F 22/20; C08F 22/24; C08K 5/1545; C08K 5/17; C09K 19/3852; C09K 19/54; C09K 2019/0448

(57) ABSTRACT

A first object of the present invention is to provide a liquid crystalline composition capable of forming a film having excellent light resistance and also having excellent alignment properties of a liquid crystal compound in the film. In addition, a second object of the present invention is to provide a cured product obtained from the liquid crystalline composition, an optically anisotropic layer, an optical element, and a light guide element.

The liquid crystalline composition of the present invention is a liquid crystalline composition containing a compound A and an antioxidant, in which the compound A is a compound having a partial structure represented by Formula (I), in a case where the compound A exhibits liquid crystallinity and the composition does not contain a liquid crystal compound B having a structure different from a structure of the compound A, a distance ΔHSP between a HSP value of the antioxidant and a HSP value of the compound A is 10.5 MPa^{0.5} or less, and in a case where the composition contains the liquid crystal compound B, a distance ΔHSP between the HSP value of the antioxidant, and an average HSP value of the HSP value of the compound A and a HSP value of the liquid crystal compound B is 10.5 MPa^{0.5} or less.

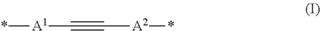

In Formula (I), A¹ and A² each independently represent an aromatic hydrocarbon ring group or an aromatic heterocyclic group, which may have a substituent. * represents a bonding position.

### CROSS-REFERENCE TO RELATED APPLICATIONS

This application is a Continuation of PCT International Application No. PCT/JP2022/046330 filed on Dec. 16, 2022, which claims priority under 35 U.S.C. § 119 (a) to Japanese Patent Application No. 2021-214383 filed on Dec. 28, 2021. The above applications are hereby expressly incorporated by reference, in their entirety, into the present application.

### BACKGROUND OF THE INVENTION

### 1. Field of the Invention

The present invention relates to a liquid crystalline composition, a cured product, an optically anisotropic layer, an optical element, and a light guide element.

### 2. Description of the Related Art

In recent years, since polarized light has been used in various optical devices or systems, there is a demand for an optical element for controlling reflection, focusing, and divergence of polarized light.

For example, WO2020/022496A discloses an optical element which includes an optically anisotropic layer consisting of a cured layer of a liquid crystalline composition containing a tolan compound as a liquid crystal compound and having a predetermined liquid crystal alignment pattern, as an optical element which has a large diffraction angle and from which diffracted light having a high diffraction efficiency is obtained.

### SUMMARY OF THE INVENTION

As a result of producing and examining a film consisting of a liquid crystalline composition containing a tolan compound with reference to WO2020/022496A, the present inventors has found that a liquid crystalline composition containing a tolan compound exhibits a high refractive index anisotropy Δn, and a film formed from the liquid crystalline composition has a high diffraction efficiency, but on the other hand, the above-described optical characteristics are difficult to be maintained because of photodegradation of the tolan compound (in other words, the diffraction efficiency may be significantly reduced because of the photodegradation of the tolan compound). That is, it has been found that there is room for improving the light resistance of the film formed of the liquid crystalline composition.

Furthermore, the film formed of the liquid crystalline composition is also required to have excellent aligning properties of the liquid crystal compound.

Therefore, an object of the present invention is to provide a liquid crystalline composition capable of forming a film having excellent light resistance and also having excellent alignment properties of a liquid crystal compound in the film.

In addition, another object of the present invention is to provide a cured product obtained from the liquid crystalline composition, an optically anisotropic layer, an optical element, and a light guide element.

In order to achieve the above objects, the inventors of the present invention carried out intensive examinations. As a result, the inventors have found that the objects can be achieved by the following constitution.

[1] A liquid crystalline composition comprising a compound A having a partial structure represented by Formula (I) and an antioxidant, in which, in a case where the compound A exhibits liquid crystallinity and the composition does not contain a liquid crystal compound B having a structure different from a structure of the compound A, a distance ΔHSP between a Hansen solubility parameter of the antioxidant and a Hansen solubility parameter of the compound A is 10.5 MPa^{0.5} or less, and in a case where the composition contains the liquid crystal compound B, a distance ΔHSP between the Hansen solubility parameter of the antioxidant, and an average Hansen solubility parameter of the Hansen solubility parameter of the compound A and a Hansen solubility parameter of the liquid crystal compound B is 10.5 MPa^{0.5} or less.

[2] The liquid crystalline composition according to [1], in which the compound A exhibits liquid crystallinity.

[3] The liquid crystalline composition according to [1] or [2], in which the compound A is a rod-like liquid crystal compound.

[4] The liquid crystalline composition according to any one of [1] to [3], in which the compound A is a polymerizable liquid crystal compound.

[5] The liquid crystalline composition according to any one of [1] to [4], in which the compound A is a compound represented by Formula (II).

[6] The liquid crystalline composition according to [5], in which, in Formula (II), at least one of P¹ or P² is a polymerizable group.

[7] The liquid crystalline composition according to any one of [1] to [6], in which the compound A is a compound represented by Formula (III) or (IV).

[8] The liquid crystalline composition according to any one of [1] to [7], in which at least one of the liquid crystal compounds B is a polymerizable liquid crystal compound.

[9] The liquid crystalline composition according to any one of [1] to [8], in which, in a case where the composition contains the liquid crystal compound B, a content of the compound A is 50% by mass or more with respect to a total content of the compound A and the liquid crystal compound B.

[10] The liquid crystalline composition according to any one of [1] to [9], in which Δn of the composition at a wavelength of 550 nm is 0.21 or more.

[11] The liquid crystalline composition according to any one of [1] to [10], in which, in a case where the compound A exhibits liquid crystallinity and the composition does not contain the liquid crystal compound B, a content of the antioxidant is 0.01% to 5% by mass with respect to a content of the compound A, and in a case where the composition contains the liquid crystal compound B, a content of the antioxidant is 0.01% to 5% by mass with respect to a total content of the compound A and the liquid crystal compound B.

[12] The liquid crystalline composition according to any one of [1] to [11], in which the antioxidant includes one or more selected from the group consisting of tertiary amines, hydroxylamines, tocopherols, catechol ethers, hindered phenols, and hindered amines.

[13] The liquid crystalline composition according to any one of [1] to [12], in which the antioxidant includes one or more selected from the group consisting of hydroxylamines, hindered phenols, and hindered amines.

[14] The liquid crystalline composition according to any one of [1] to [13], in which the antioxidant includes hydroxylamines.

[15] The liquid crystalline composition according to [14], in which the hydroxylamines are a compound represented by Formula (V).

[16] The liquid crystalline composition according to any one of [1] to [15], further containing a polymerization initiator.

[17] The liquid crystalline composition according to any one of [1] to [16], further containing a chiral agent.

[18] A cured product obtained by curing the liquid crystalline composition according to any one of [1] to [17].

[19] An optically anisotropic layer consisting of the cured product according to [18].

[20] The optically anisotropic layer according to [19], in which the optically anisotropic layer has an alignment pattern, and the alignment pattern is an alignment pattern in which an orientation of an optical axis derived from a liquid crystal compound contained in the composition is changed while continuously rotating along at least one in-plane direction.

[21] An optical element comprising the optically anisotropic layer according to [20].

[22] A light guide element comprising the optical element according to and a light guide plate.

According to the present invention, a liquid crystalline composition capable of forming a film having excellent light resistance and also having excellent alignment properties of a liquid crystal compound in the film can be provided.

In addition, according to the present invention, a cured product obtained from the liquid crystalline composition, an optically anisotropic layer, an optical element, and a light guide element can be provided.

### BRIEF DESCRIPTION OF THE DRAWINGS

FIG. 1 is a schematic view showing an embodiment of an optically anisotropic layer.

FIG. 2 is a schematic plan view of the optically anisotropic layer shown in FIG. 1.

FIG. 3 is a conceptual diagram showing an action of the optically anisotropic layer shown in FIG. 2.

FIG. 4 is a conceptual diagram showing an action of the optically anisotropic layer shown in FIG. 2.

FIG. 5 is a schematic view showing another example of the optically anisotropic layer.

FIG. 6 is a schematic view showing another example of the optically anisotropic layer.

### DESCRIPTION OF THE PREFERRED EMBODIMENTS

Hereinafter, the present invention will be described in detail.

Although the configuration requirements to be described below may be described based on representative embodiments of the present invention, the present invention is not limited to such embodiments.

In each of the drawings, for easy visual recognition, the reduced scale of components is different from the actual scale.

In addition, in this specification, a numerical range represented using “to” means a range that includes numerical values written before and after “to” as a lower limit and an upper limit.

In addition, in the present specification, “perpendicular” or “parallel” regarding an angle represents a range of the exact angle±10°.

In addition, in the present specification, Re(λ) represents an in-plane retardation at a wavelength 2. Unless otherwise specified, the wavelength λ is 550 nm.

In addition, in this specification, Re(λ) is a value measured at the wavelength λ using AxoScan (manufactured by Axometrics, Inc.). By inputting an average refractive index ((nx+ny+nz)/3) and a film thickness (d (μm)) to AxoScan, the following expressions can be calculated.

Slow Axis Direction (°): Re(λ)=R0(λ)

Although R0(λ) is displayed as a numerical value calculated by AxoScan, it means Re(λ).

In addition, in the present specification, “(meth)acryloyloxy group” is a notation representing both an acryloyloxy group and a methacryloyloxy group, and “(meth)acrylate” is a notation representing both an acrylate and a methacrylate.

In addition, in a notation for a group (atomic group) in the present specification, in a case where the group is denoted without specifying whether it is substituted or unsubstituted, the group includes both a group having no substituent and a group having a substituent. For example, an “alkyl group” includes not only an alkyl group having no substituent (unsubstituted alkyl group), but also an alkyl group having a substituent (substituted alkyl group).

In addition, in the present specification, in a case where a “substituent” is simply described, examples of the substituent include the following substituent L.

### (Substituent L)

Examples of the substituent L include an alkyl group having 1 to 10 carbon atoms, an alkoxy group having 1 to 10 carbon atoms, an alkylamino group having 1 to 10 carbon atoms, an alkylthio group having 1 to 10 carbon atoms, an alkanoyl group having 1 to 10 carbon atoms, an alkanoyloxy group having 1 to 10 carbon atoms, an alkanoylamino group having 1 to 10 carbon atoms, an alkanoylthio group having 1 to 10 carbon atoms, an alkyloxycarbonyl group having 2 to 10 carbon atoms, an alkylaminocarbonyl group having 2 to 10 carbon atoms, an alkylthiocarbonyl group having 2 to 10 carbon atoms, a hydroxy group, an amino group, a mercapto group, a carboxy group, a sulfo group, an amido group, a cyano group, a nitro group, a halogen atom, a polymerizable group, and the like. Provided that, in a case where the group described as the substituent L contains —CH₂— (methylene group), a group in which at least one —CH₂— contained in the group is substituted with —O—, —CO—, —CH═CH—, or —C≡C— is also included in the substituent L. For example, in a case where the above-described group has two or more —CH₂—'s, one —CH₂— may be substituted with —O— and one —CH₂— adjacent to the —O— may be substituted with —CO— to form an ester group (—O—CO—). Here, in a case where the group described as the substituent L has a hydrogen atom, a group in which at least one hydrogen atom-in the group is substituted with at least one selected from the group consisting of a fluorine atom and a polymerizable group is also included in the substituent L.

Examples of the above-described polymerizable group include an ethylenically unsaturated group, a ring-polymerizable group, and the like, and among these, a substituent selected from a polymerizable group P, which will be described later, is preferable.

Among these, the substituent L is preferably an alkyl group having 1 to 10 carbon atoms, an alkoxy group having 1 to 10 carbon atoms, an alkanoyl group having 1 to 10 carbon atoms, an alkanoyloxy group having 1 to 10 carbon atoms, an alkyloxycarbonyl group having 2 to 10 carbon atoms, a trifluoromethyl group, a hydroxy group, a carboxy group, a cyano group, a nitro group, or a halogen atom, more preferably an alkyl group having 1 to 10 carbon atoms, an alkoxy group having 1 to 10 carbon atoms, an alkanoyl group having 2 to 10 carbon atoms, an alkanoyloxy group having 2 to 10 carbon atoms, an alkyloxycarbonyl group having 2 to 10 carbon atoms, a trifluoromethyl group, or a halogen atom, and still more preferably an alkyl group having 1 to 6 carbon atoms, an alkoxy group having 1 to 6 carbon atoms, an alkanoyl group having 2 to 6 carbon atoms, an alkanoyloxy group having 2 to 6 carbon atoms, an alkyloxycarbonyl group having 2 to 6 carbon atoms, a trifluoromethyl group, or a fluorine atom.

In addition, in the present specification, in a case of simply referring to a “polymerizable group”, examples of the polymerizable group include the following polymerizable group P.

### (Polymerizable Group P)

Examples of the polymerizable group P include a group represented by any one of Formulae (P-1) to (P-19) below. In the following formulae, * represents a bonding position, Me represents a methyl group, and Et represents an ethyl group. Among these, Formula (P-1) or Formula (P-2) (a (meth)acryloyloxy group) is preferable.

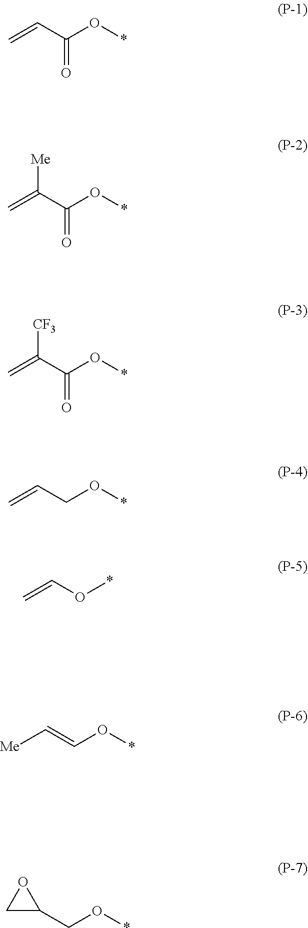

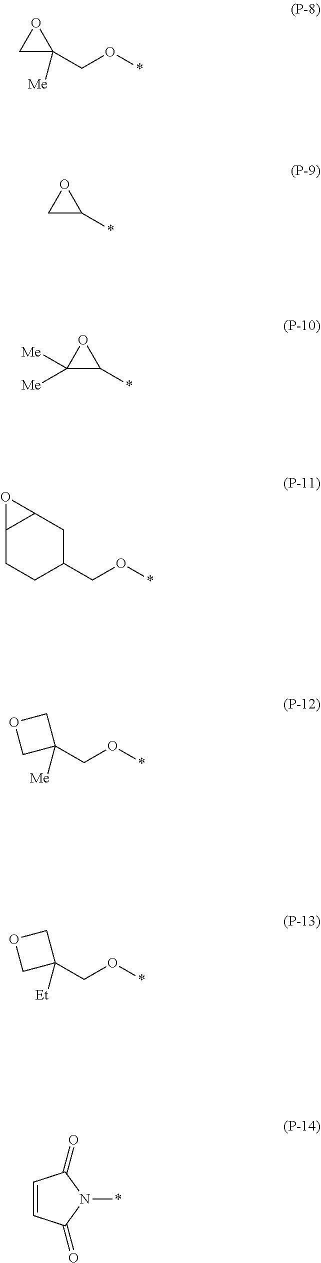

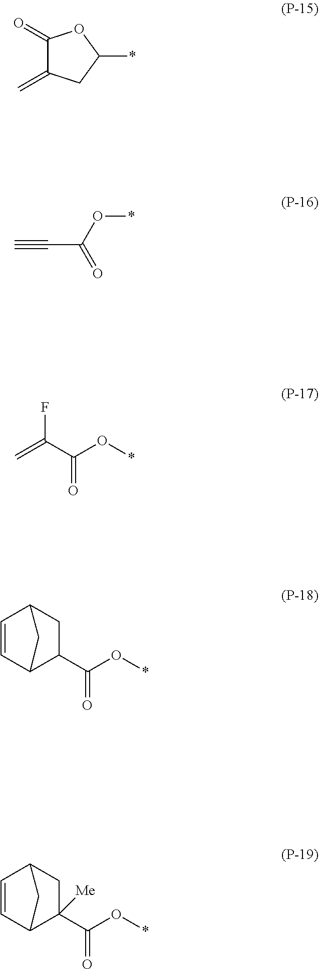

In addition, in the present specification, a “solid content” of a composition refers to components which form a composition layer formed of the composition, and in a case where the composition includes a solvent (an organic solvent, water, and the like), the solid content means all components except the solvent. In addition, in a case where the components are components which form a composition layer, the components are considered to be solid contents even in a case where the components are liquid components.

In addition, in the present specification, unless otherwise specified, a thickness of a layer is an average value of the thicknesses obtained by observing a cross section cut by a microtome with a scanning electron microscope (SEM) or a transmission electron microscope (TEM) and measuring the thickness at 10 points.

### [Liquid Crystalline Composition]

A liquid crystalline composition according to the embodiment of the present invention contains a compound A having a partial structure represented by Formula (I), which will be described later and an antioxidant, in which, in a case where the compound A exhibits liquid crystallinity and the composition does not contain a liquid crystal compound B (hereinafter, also referred to as a “liquid crystal compound B”) having a structure different from a structure of the compound A, a distance ΔHSP between a Hansen solubility parameter of the antioxidant and a Hansen solubility parameter of the compound A is 10.5 MPa^{0.5} or less, and in a case where the composition contains the liquid crystal compound B, a distance ΔHSP between the Hansen solubility parameter of the antioxidant, and an average Hansen solubility parameter of the Hansen solubility parameter of the compound A and a Hansen solubility parameter of the liquid crystal compound B is 10.5 MPa^{0.5} or less.

In the following, among the compounds A, a compound A exhibiting liquid crystallinity may be referred to as a “liquid crystal compound A”, and a compound A not exhibiting liquid crystallinity may be referred to as a “non-liquid crystal compound A”.

In addition, the liquid crystal compound B (liquid crystal compound B) having a structure different from that of the above-described compound A is a liquid crystal compound having a structure different from that of the compound A, that is, it is intended to be a liquid crystal compound not having a partial structure represented by Formula (I) described later.

The film formed from the liquid crystalline composition according to the embodiment of the present invention having the above-described configuration has a high diffraction efficiency because the liquid crystalline composition contains a tolan compound (compound A), and can maintain the high diffraction efficiency over a long period of time by suppressing photodegradation (in other words, having excellent light resistance). In addition, in the film, the alignment properties of the liquid crystal compound are also excellent.

A reason therefor is not clear in detail, but is presumed as follows by the present inventors.

Recently, the present inventors have found that, in the film of the liquid crystalline composition containing a tolan compound, the light diffraction efficiency is reduced by photodegradation (for example, oxidation, radical decomposition, and the like) of the tolan compound caused by singlet oxygen generated by light irradiation. On the other hand, it is considered that since the liquid crystalline composition according to the embodiment of the present invention contains the antioxidant, the generation of singlet oxygen, which causes photodegradation of the tolan compound, is suppressed, and as a result, the formed film has excellent light resistance. In addition, it is considered that the distance ΔHSP between the Hansen solubility parameter (HSP) value of the antioxidant and the HSP value of the liquid crystal compound A (in a case where the liquid crystalline composition contains only the liquid crystal compound A as the liquid crystal compound (corresponding to a first aspect which will be described later)) or the distance ΔHSP between the HSP value of the antioxidant and the average HSP value of the compound A and the liquid crystal compound B (in a case where the liquid crystalline composition contains the compound A and the liquid crystal compound B (corresponding to a second aspect and a third aspect, which will be described later)) is set to be equal to or less than a predetermined value in the liquid crystalline component, the alignment properties of the liquid crystal compound in the film are also excellent.

Hereinafter, there is a case where the more excellent light resistance of the film formed from the liquid crystalline composition according to the embodiment of the present invention and/or the more excellent aligning properties of the liquid crystal compound in the film may be referred to the “more excellent effect of the present invention”.

### [Specific Aspect of Liquid Crystalline Composition]

First, specific examples of the liquid crystalline composition include the following aspects.
First aspect: the liquid crystalline composition contains only the liquid crystal compound A as the liquid crystal compound, and a distance ΔHSP between an HSP value of the antioxidant and an HSP value of the compound A is 10.5 MPa^{0.5} or less.
Second aspect: the liquid crystal composition contains the liquid crystal compound A and the liquid crystal compound B as the liquid crystal compound, and a distance ΔHSP between the HSP value of the antioxidant and an average HSP value of the liquid crystal compound A and the liquid crystal compound B is 10.5 MPa^{0.5} or less.
Third aspect: the liquid crystalline composition contains the non-liquid crystal compound A and the liquid crystal compound B, and a distance ΔHSP between the HSP value of the antioxidant and an average HSP value of the non-liquid crystal compound A and the liquid crystal compound B is 10.5 MPa^{0.5} or less.

In the first to third aspects, the definitions of the liquid crystal compound A, the liquid crystal compound B, and the non-liquid crystal compound A are as described above.

In addition, the liquid crystalline composition according to the first aspect does not contain the other liquid crystal compound (liquid crystal compound B) having a structure different from the compound A.

Hereinafter, first, each component in the liquid crystalline composition will be described. The liquid crystalline composition may further contain various components such as a polymerization initiator described later, in addition to the liquid crystal compound and the antioxidant.

### [Various Components]

### <Compound (Compound A) Having Partial Structure Represented by Formula (I)>

The liquid crystalline composition contains a compound (compound A) having a partial structure represented by Formula (I).

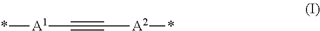

In Formula (I), A¹ and A² each independently represent an aromatic hydrocarbon ring group or an aromatic heterocyclic group, which may have a substituent. * represents a bonding position.

The aromatic hydrocarbon ring group may be a monocyclic structure or a polycyclic structure.

The aromatic hydrocarbon ring group is not particularly limited, but is preferably an arylene group, more preferably an arylene group having 6 to 20 carbon atoms, still more preferably an arylene group having 6 to 10 carbon atoms, and particularly preferably a phenylene group or a naphthylene group.

The aromatic heterocyclic group may be a monocyclic structure or a polycyclic structure. Among these, the aromatic heterocyclic group is preferably a 5-membered or 6-membered monocyclic aromatic heterocyclic group. A heteroatom contained in the aromatic heterocyclic group is not particularly limited, and examples thereof include an oxygen atom, a nitrogen atom, and a sulfur atom.

The aromatic heterocyclic group is not particularly limited, but is preferably a heteroarylene group, more preferably a heteroarylene group having 3 to 20 carbon atoms, and still more preferably a heteroarylene group having 3 to 10 carbon atoms. The heteroatom contained in the heteroarylene group is preferably at least one selected from the group consisting of a nitrogen atom, an oxygen atom, and a sulfur atom.

The substituent which may be contained in the above-described aromatic hydrocarbon ring group and aromatic heterocyclic group is not particularly limited, but is preferably a substituent selected from the above-described substituent L.

The compound A may or may not exhibit liquid crystallinity.

In general, the liquid crystal compound can be classified into a rod-like type and a disk-like type according to the shape thereof. Furthermore, the above-described types of compounds respectively include a low-molecular-weight type compound and a polymer type compound. The term, polymer, generally refers to a molecule having a polymerization degree of 100 or more (Masao Doi, Polymer Physics-Phase Transition Dynamics, page 2, Iwanami Shoten, Publishers, 1992). In a case where the compound A exhibits liquid crystallinity, the liquid crystal compound A may be any of the above-described compounds, but among these, a rod-like liquid crystal compound is preferable.

In addition, in a case where the compound A exhibits liquid crystallinity, the liquid crystal compound A is also preferably a liquid crystal compound having a polymerizable group in the molecule (hereinafter, also referred to as “polymerizable liquid crystal compound”).

Examples of the polymerizable group include an ethylenically unsaturated group and a ring-polymerizable group, and specific examples thereof include a vinyl group, a styryl group, an allyl group, and a substituent selected from the above-described polymerizable group P. In a case where the liquid crystal compound A has a polymerizable group, it is preferable that two or more polymerizable groups are contained in one molecule from the viewpoint of immobilizing the alignment.

The molecular weight of the compound A is, for example, preferably 200 to 100,000, more preferably 300 to 10,000, and still more preferably 400 to 2,500. In a case where the compound A is a polymer, the above-described molecular weight means a weight-average molecular weight.

From the viewpoint of more excellent effect of the present invention, the compound A is preferably a compound represented by Formula (II), and more preferably a compound represented by Formula (III) or Formula (IV).

Hereinafter, the compounds represented by Formulae (II) to (IV) will be described.

### (Compound Represented by Formula (II))

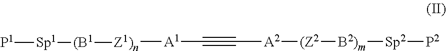

In Formula (II), P¹ and P² each independently represent a hydrogen atom, a halogen atom, —CN, —NCS, or a polymerizable group.

P¹ and P² are each independently preferably a polymerizable group. The polymerizable group is not particularly limited, and examples thereof include an ethylenically unsaturated group, a ring-polymerizable group, and the like, but is preferably a substituent selected from the above-described polymerizable group P.

In Formula (II), Sp¹ and Sp² each independently represent a single bond or a divalent linking group. Provided that Sp¹ and Sp² do not represent a divalent linking group including at least one group selected from the group consisting of an aromatic hydrocarbon ring group, an aromatic heterocyclic group, and an aliphatic hydrocarbon ring group.

The divalent linking group represented by Sp¹ and Sp² is not particularly limited, but is preferably an alkylene group (preferably an alkylene group having 1 to 20 carbon atoms), an alkenylene group (preferably an alkenylene group having 2 to 20 carbon atoms), —O—, —S—, —CO—, —SO—, —SO₂—, —COO—, —OCO—, —CO—S—, —S—CO—, —O—CO—O—, or a divalent linking group obtained by combining a plurality of these.

Among these, Sp¹ and Sp² are each independently preferably a single bond or an alkylene group having 1 to 10 carbon atoms, —O—, —S—, —CO—, —COO—, —OCO—, or a divalent linking group obtained by combining a plurality of these, more preferably a single bond or an alkylene group having 1 to 6 carbon atoms, —O—, —S—, or a divalent linking group obtained by combining a plurality of these, and still more preferably a single bond or an alkylene group having 1 to 4 carbon atoms, —O—, —S—, or a divalent linking group obtained by combining a plurality of these.

In Formula (II), Z¹ and Z² each independently represent a single bond or a divalent linking group. In a case where there are a plurality of Z¹'s and a plurality of Z²'s, the plurality of Z¹'s may be the same as or different from each other and the plurality of Z²'s may be the same as or different from each other. Provided that Z′ and Z² do not represent a divalent linking group including at least one group selected from the group consisting of an aromatic hydrocarbon group, an aromatic heterocyclic ring group, and an aliphatic hydrocarbon ring group.

The divalent linking group represented by Z¹ and Z² is not particularly limited, but is preferably an alkylene group (preferably an alkylene group having 1 to 20 carbon atoms), an alkenylene group (preferably an alkenylene group having 2 to 20 carbon atoms), an alkynylene group (preferably an alkynylene group having 2 to 20 carbon atoms), —O—, —S—, —CO—, —SO—, —SO₂—, —COO—, —OCO—, —CO—S—, —S—CO—, —O—CO—O—, or a divalent linking group obtained by combining a plurality of these.

Specific examples of the divalent linking group represented by Z¹ and Z² include-O—, —S—, —CHRCHR—, —OCHR—, —CHRO—, —CO—, —SO—, —SO₂—, —COO—, —OCO—, —CO—S—, —S—CO—, —O—CO—O—, —CO—NR—, —NR—CO—, —SCHR—, —CHRS—, —SO—CHR—, —CHR—SO—, —SO₂—CHR—, —CHR—SO₂—, —CF₂O—, —OCF₂—, —CF₂S—, —SCF₂—, —OCHRCHRO—, —SCHRCHRS—, —SO—CHRCHR—SO—, —SO₂—CHRCHR—SO₂—, —CH═CH—COO—, —CH═CH—OCO—, —COO—CH═CH—, —OCO—CH—CH—, —COO—CHRCHR—, —OCO—CHRCHR—, —CHRCHR—COO—, —CHRCHR—OCO—, —COO—CHR—, —OCO—CHR—, —CHR—COO—, —CHR—OCO—, —CR═CR—, —CR═N—, —N═CR—, —N═N—, —CR═N—N—CR—, —CF—CF—, and —C≡C—.

R represents a hydrogen atom or an alkyl group having 1 to 10 carbon atoms. R is preferably a hydrogen atom or an alkyl group having 1 to 6 carbon atoms, more preferably a hydrogen atom or an alkyl group having 1 to 4 carbon atoms, and still more preferably a hydrogen atom. In a case where a plurality of R's are present, the plurality of R's may be the same as or different from each other.

Among these, Z¹ and Z² are each independently preferably-CHRCHR—, —OCHR—, —CHRO—, —COO—, —OCO—, —CO—NH—, —NH—CO—, or —C≡C—, and more preferably —CHRCHR—, —OCHR—, —CHRO—, or —C≡C—.

In Formula (II), A¹ and A² each independently represent an aromatic hydrocarbon ring group or an aromatic heterocyclic group, which may have a substituent.

A¹ and A² have the same definition as A¹ and A² in Formula (I), and the suitable aspect thereof is also the same.

B¹ and B² each independently represent an aromatic hydrocarbon ring group, an aromatic heterocyclic group, or an aliphatic hydrocarbon ring group, which may have a substituent. In a case where there are a plurality of B¹'s and a plurality of B²'s, the plurality of B¹'s may be the same as or different from each other and the plurality of B²'s may be the same as or different from each other.

The aromatic hydrocarbon ring group may be a monocyclic structure or a polycyclic structure.

The aromatic hydrocarbon ring group is not particularly limited, but is preferably an arylene group, more preferably an arylene group having 6 to 20 carbon atoms, still more preferably an arylene group having 6 to 10 carbon atoms, and particularly preferably a phenylene group or a naphthylene group.

The aromatic heterocyclic group may be a monocyclic structure or a polycyclic structure. Among these, the aromatic heterocyclic group is preferably a 5-membered or 6-membered monocyclic aromatic heterocyclic group. A heteroatom contained in the aromatic heterocyclic group is not particularly limited, and examples thereof include an oxygen atom, a nitrogen atom, and a sulfur atom.

The aromatic heterocyclic group is not particularly limited, but is preferably a heteroarylene group, more preferably a heteroarylene group having 3 to 20 carbon atoms, and still more preferably a heteroarylene group having 3 to 10 carbon atoms. The heteroatom contained in the heteroarylene group is preferably at least one selected from the group consisting of a nitrogen atom, an oxygen atom, and a sulfur atom.

The aliphatic hydrocarbon ring group may have a monocyclic structure or may have a polycyclic structure.

The aliphatic hydrocarbon ring group is not particularly limited, and examples thereof include a cycloalkylene group and the like. Among these, the cycloalkylene group is preferably a cycloalkylene group having 3 to 20 carbon atoms, and more preferably a cycloalkylene group having 3 to 10 carbon atoms.

The substituent which may be contained in the aromatic hydrocarbon ring group, aromatic heterocyclic group, and aliphatic hydrocarbon ring group is not particularly limited, but is preferably a substituent selected from the above-described substituent L.

In Formula (II), n and m each independently represent an integer in a range of 0 to 4.

Among these, n and m each independently preferably represent an integer in a range of 0 to 3, and more preferably represent an integer in a range of 0 to 2.

### (Compound Represented by Formula (III) and Compound Represented by Formula (IV))

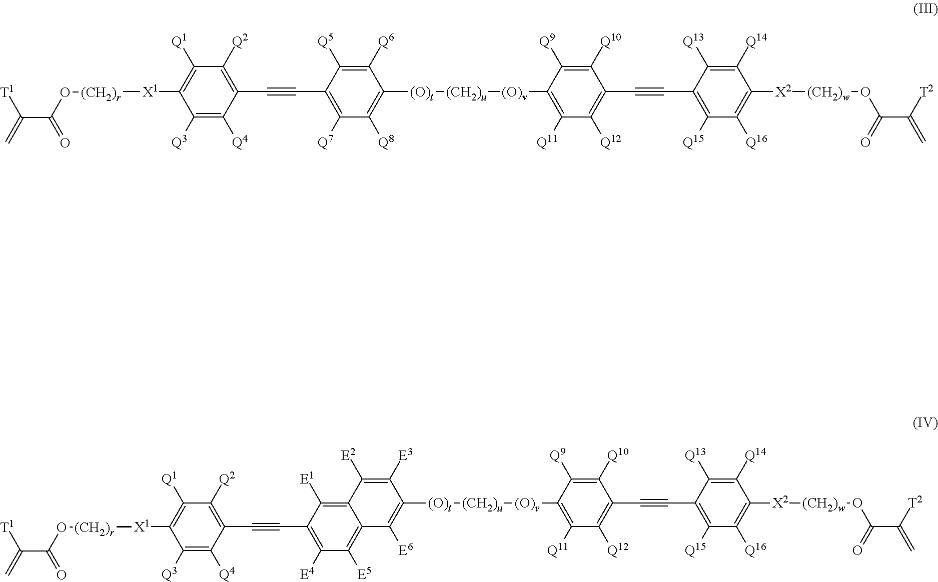

In Formula (III) and Formula (IV), T¹ and T² each independently represent a hydrogen atom or a methyl group.
X¹ and X² each independently represent a methylene group, an oxygen atom, or a sulfur atom.
r represents an integer in a range of 1 to 5.
t and v each independently represent 0 or 1.
u represents 1 or 2.
w represents an integer in a range of 1 to 5.
Q¹ to Q¹⁶ each independently represent a hydrogen atom or a substituent.
E¹ to E⁶ each independently represent a hydrogen atom or a substituent.

The substituent represented by Q¹ to Q¹⁶ is not particularly limited, but is preferably a substituent selected from the above-described substituent L.

The substituent represented by E¹ to E⁶ is not particularly limited, but is preferably a substituent selected from the above-described substituent L.

Specific examples of the compound A are not particularly limited, and examples thereof include compounds described in JP2009-102245A, JP4655348B, JP4524827B, JP4720200B, JP2004-091380A, JP3972430B, JP4517416B, JP2002-128742A, JP4810750B, JP5888544B, JP2014-019654A, JP6241654B, JP6372060B, JP6323144B, JP2005-015406A, JP2007-230968A, JP6761484B, JP6681992B, WO2019/182129A, CN01134217A, KR101069555B, KR101690767B, CN20120229730A, JP4053782B, JP2009-249406A, JP4121075B, JP2005-528416A, U.S. Pat. No. 6,514,578B, WO2006/006819A, JP2011-184417A, JP2013-095685A, JP2013-103897A, JP2002-088008A, JP2002-226412A, JP2012-167214A, JP2012-167068A, JP2018-084511A, JP2003-055317A, JP2001-329264A, JP2002-030016A, JP2003-055664A, JP2018-070889A, CN102557896B, US2015369982A, JP2020-105264A, JP2014-224237A, JP2012-051862A, JP2010-106274A, JP2005-179557A, JP2005-035985A, JP2002-012579A, JP2002-003845A, JP2001-233837A, JP2019-532167A, JP2016-509247A, JP2010-503733A, JP2003-533557A, WO2019/098115A, WO2018/034216A, WO2018/221236A, WO2018/123396A, WO2018/003482A, WO2017/086143A, WO2014/192655A, WO2013/161669A, WO2009/104468A.

In addition, examples of the compound A also include the following compounds.

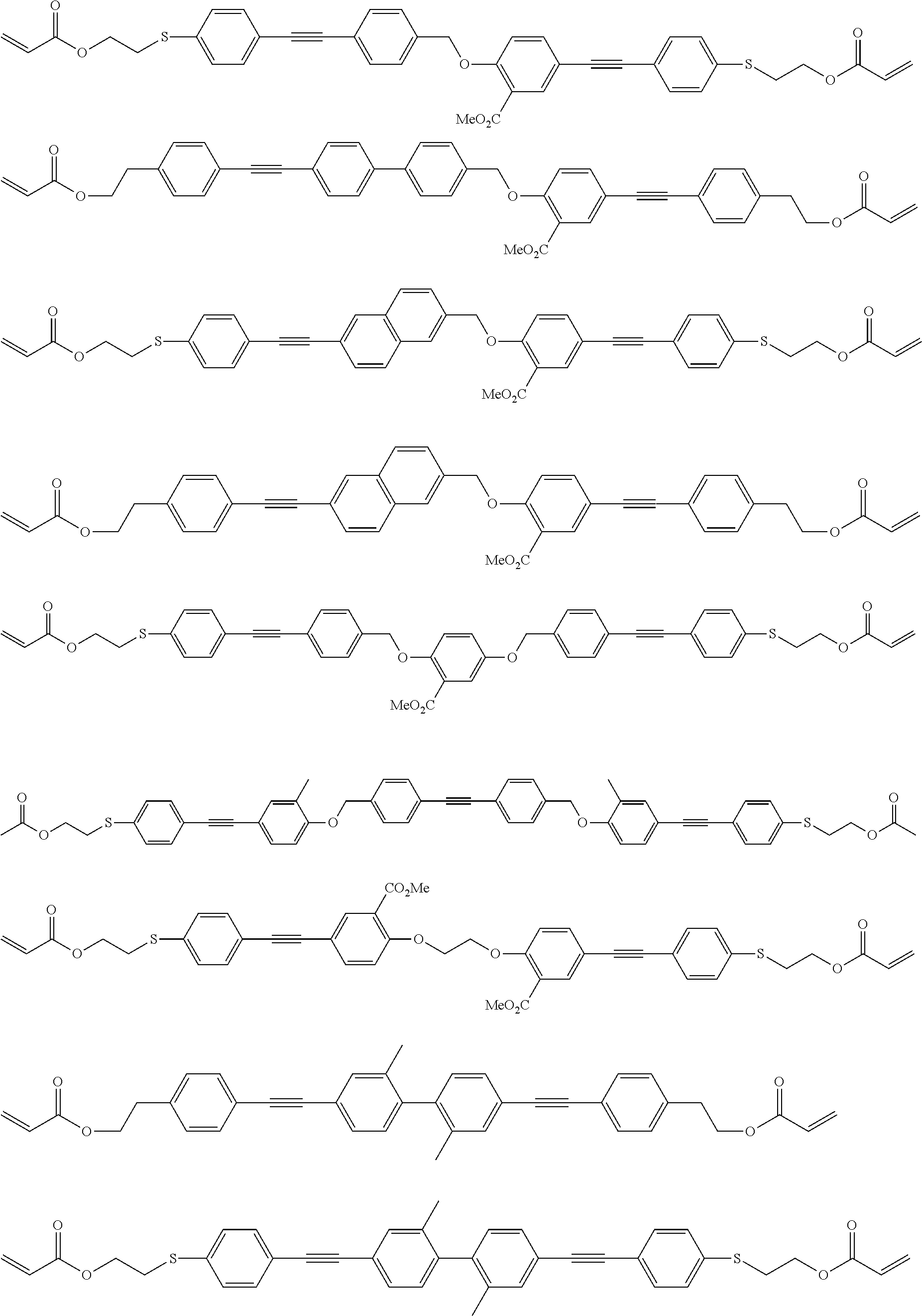

As described above, the compound A may include the liquid crystal compound A (compound A exhibiting liquid crystallinity) and the non-liquid crystal compound A (compound A not exhibiting liquid crystallinity).

Here, the liquid crystal compound A is intended to be a compound having the partial structure represented by Formula (I), in which a transition temperature to a liquid crystal phase in a case of temperature decrease is 1° C. or more. In the refractive index anisotropy Δn of the liquid crystal compound A, Δn at a wavelength of 550 nm is preferably 0.20 or more, more preferably 0.24 or more, and still more preferably 0.28 or more.

<Other Liquid Crystal Compound (Liquid Crystal Compound B) Having a Structure Different from that of Compound A>

The liquid crystalline composition may contain the other liquid crystal compound (liquid crystal compound B) having a structure different from the compound A.

In general, the liquid crystal compound can be classified into a rod-like type and a disk-like type according to the shape thereof. Furthermore, the above-described types of compounds respectively include a low-molecular-weight type compound and a polymer type compound. The term, polymer, generally refers to a molecule having a polymerization degree of 100 or more (Masao Doi, Polymer Physics-Phase Transition Dynamics, page 2, Iwanami Shoten, Publishers, 1992).

The liquid crystal compound B is not particularly limited, and any compound may be used. Among these, from the viewpoint of more excellent effect of the present invention, a rod-like liquid crystal compound or a disk-like liquid crystal compound (discotic liquid crystal compound) is preferable, and a rod-like liquid crystal compound is more preferable.

In addition, the liquid crystal compound B is also preferably a liquid crystal compound having a polymerizable group in the molecule (a polymerizable liquid crystal compound).

Examples of the polymerizable group include an ethylenically unsaturated group and a ring-polymerizable group, and specific examples thereof include a vinyl group, a styryl group, an allyl group, and a substituent selected from the above-described polymerizable group P.

In a case of containing a polymerizable group in the liquid crystal compound B, the number of polymerizable groups is not particularly limited, but is, for example, one or more, and from the viewpoint of immobilizing the alignment, the liquid crystal compound B has more preferably two or more polymerizable groups in one molecule. The upper limit value thereof is, for example, preferably 6 or less and more preferably 3 or less.

The liquid crystal compound B may be used alone or in combination of two or more types thereof.

In a case where two or more liquid crystal compounds B are used in combination, any form of a mixture of two or more rod-like liquid crystal compounds, a mixture of two or more disk-like liquid crystal compounds, and a mixture of a rod-like liquid crystal compound and a disk-like liquid crystal compound may be adopted.

In a case where a plurality of types of the liquid crystal compounds B are used in combination, it is also preferable that at least one or more of the liquid crystal compounds B is a polymerizable liquid crystal compound.

As the liquid crystal compound B, known compounds can be used.

As the rod-like liquid crystal compound, for example, compounds described in [claim 1] of JP1999-513019A (JP-H11-513019A) and paragraphs to of JP2005-289980A, and the like can be suitably used.

In addition, as the disk-like liquid crystal compound, for example, compounds described in paragraphs to of JP2007-108732A and paragraphs to of JP2010-244038A, and the like can be suitably used.

From the viewpoint of more excellent effect of the present invention, the liquid crystal compound B is preferably a rod-like liquid crystal compound, and more preferably azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, or alkenylcyclohexylbenzonitriles.

The liquid crystal compound B is more preferably as a refractive index anisotropy Δn is higher, and specifically, Δn at a wavelength of 550 nm is preferably 0.15 or more, more preferably 0.18 or more, and still more preferably 0.22 or more. The upper limit thereof is not particularly limited, but is 0.20 or less in many cases.

### <Content of Compound a and Liquid Crystal Compound>

The content of the liquid crystal compound in the liquid crystalline composition is preferably 50% to 100% by mass, more preferably 65% to 100% by mass, and still more preferably 80% to 100% by mass with respect to the solid content of the liquid crystalline composition.

In addition, the content of the compound A (the total content of the liquid crystal compound A and the non-liquid crystal compound A) in the liquid crystalline composition is preferably 20% to 100% by mass, more preferably 50% to 100% by mass, and still more preferably 70% to 100% by mass with respect to the total solid content of the liquid crystalline composition.

### <Suitable Aspect of Liquid Crystal Composition of First to Third Aspects>

In a case where the liquid crystalline composition is the liquid crystalline composition according to the first aspect, the liquid crystal compound A is preferably a polymerizable liquid crystal compound having two or more polymerizable groups.

In addition, in a case where the liquid crystalline composition is the liquid crystalline composition according to the first aspect, it is preferable that the liquid crystal compound A is a rod-like liquid crystal compound.

In a case where the liquid crystalline composition is the liquid crystalline composition according to the second aspect, it is preferable that at least one of the liquid crystal compound A or the liquid crystal compound B is a polymerizable liquid crystal compound having two or more polymerizable groups, and it is more preferable that both the liquid crystal compound A and the liquid crystal compound B are polymerizable liquid crystal compounds having two or more polymerizable groups.

In a case where the liquid crystalline composition is the liquid crystalline composition according to the second aspect, the content of the liquid crystal compound A is preferably 50% by mass or more, more preferably 70% by mass or more, and still more preferably 85% by mass or more with respect to the total content of the liquid crystal compound A and the liquid crystal compound B. The upper limit thereof is not particularly limited, but is preferably 95% by mass or less.

In addition, in a case where the liquid crystalline composition is the liquid crystalline composition according to the second aspect, it is preferable that both the liquid crystal compound A and the liquid crystal compound B are a rod-like liquid crystal compound.

In a case where the liquid crystalline composition is the liquid crystalline composition according to the third aspect, it is preferable that at least one of the non-liquid crystal compound A or the liquid crystal compound B has two or more polymerizable groups, and it is more preferable that both the non-liquid crystal compound A and the liquid crystal compound B have two or more polymerizable groups.

In a case where the liquid crystalline composition is the liquid crystalline composition according to the third aspect, the content of the non-liquid crystal compound A is preferably 20% by mass or more, more preferably 30% by mass or more, still more preferably 40% by mass or more, and particularly preferably 50% by mass or more with respect to the total content of the non-liquid crystal compound A and the liquid crystal compound B. The upper limit is not particularly limited, but is preferably 80% by mass or less and more preferably 60% by mass or less.

In addition, in a case where the liquid crystalline composition is the liquid crystalline composition according to the third aspect, it is preferable that the liquid crystal compound B is a rod-like liquid crystal compound.

### <Antioxidant>

The liquid crystalline composition contains an antioxidant for the purpose of improving light resistance of the formed film. As the antioxidant, from the viewpoint that the alignment properties of the liquid crystal compound in the film are excellent, an antioxidant satisfying the following physical properties in a relationship between the compound A and the liquid crystal compound B is selected.

### (Relationship Between Antioxidant, and Compound A and Liquid Crystal Compound B)

In a case where the liquid crystalline composition is the above-described liquid crystalline composition of the aspect 1, from the viewpoint that the alignment properties of the liquid crystal compound in the film are excellent, the distance ΔHSP between the HSP value of the antioxidant and the HSP value of the compound A is 10.5 MPa^{0.5} or less, and from the viewpoint of more excellent effect of the present invention, is preferably 9.1 MPa^{0.5} or less. The lower limit value thereof is not particularly limited, but is preferably 0.1 MPa^{0.5} or more.

In addition, in a case where the liquid crystalline composition is the above-described liquid crystalline composition of the aspect 2 or the aspect 3, from the viewpoint that the alignment properties of the liquid crystal compound in the film are excellent, the distance ΔHSP between the HSP value of the antioxidant and the average HSP value of the compound A and the liquid crystal compound B is 10.5 MPa^{0.5} or less, and from the viewpoint of more excellent effect of the present invention, is preferably 9.1 MPa^{0.5} or less. The lower limit value thereof is usually 0 MPa^{0.5} or more.

The distance ΔHSP value is obtained by the following procedure.

(1) First, using the commercially available software “HSPiP”, three vectors of Hansen solubility parameter (dispersion element component of Hansen solubility parameter vector: δD, polar element component of Hansen solubility parameter vector: δP, and hydrogen bonding element component of Hansen solubility parameter vector: δH) are obtained for each of the antioxidant, the compound A, and the liquid crystal compound B.

(2) In a case where the liquid crystalline composition contains both the compound A and the liquid crystal compound B, the average δDₓ of the compound A and the liquid crystal compound B is calculated according to the following expression.

$$Average δ {D}_{x} = δ {D}_{1} \times {W}_{1} + δ {D}_{2} \times {W}_{2} + … {δD}_{n} \times {W}_{n}$$

Here, δDₙ represents δD of each compound corresponding to the compound A and the liquid crystal compound B, and Wₙ represents a content of each compound (mass fraction: content ratio of each compound with respect to the total content of each compound) described above.

For example, in a case where the optically anisotropic layer contains the compound A and the liquid crystal compound B in equal amount to each, the average δDₓ=δD₁×W₁+δD₂×W₂ (δD₁ and δD₂ each represent δD of the compound A and the liquid crystal compound B, and W₁ and W₂ represent 0.5).

(3) According to the same procedure as in (2), the average δPₓ and the average δHₓ of the compound A and the liquid crystal compound B are each calculated.

(4) The distance ΔHSP is derived according to the following expression.

$$Δ HSP value = {\{ 4 \times {( δ {D}_{A} - δ {D}_{B} )}^{2} + {( δ {P}_{A} - δ {P}_{B} )}^{2} + {( δ {H}_{A} - δ {H}_{B} )}^{2} \}}^{0.5}$$

Here, in a case where the liquid crystalline composition contains both the compound A and the liquid crystal compound B, δD_{A}, δP_{A}, and δH_{A} each represent an average δDₓ, an average δPₓ, and an average δHₓ of the compound A and the liquid crystal compound B. In a case where the liquid crystalline composition contains only the compound A and does not contain liquid crystal compound B, δD_{A}, δP_{A}, and δH_{A} each represent δD, δP, and δH of the compound A. In addition, δD_{B}, δP_{B}, and δH_{B} represent δD, δP, and δH of the antioxidant.

The antioxidant is not particularly limited, and examples thereof include a known compound as the antioxidant such as a radical scavenging agent, a peroxide decomposing agent, an ultraviolet absorber, a singlet oxygen quencher, and an oil-soluble antioxidant.

### (Radical Scavenging Agent)

Examples of the radical scavenging agent include a phenol-based antioxidant, an amine-based antioxidant, and the like.

Examples of the phenol-based antioxidant include a hydroxyphenylpropionate-based compound, a hydroxybenzyl-based compound, a thiobisphenol-based compound, a thiomethylphenol-based compound, and an alkanediylphenol-based compound, and from the viewpoint that the stability of the color characteristics is more excellent, a hydroxyphenylpropionate-based compound is preferable.

Specific examples of the phenol-based antioxidant include substituted phenols such as 1-oxy-3-methyl-4-isopropylbenzene, 2,6-di-t-butylphenol, 2,6-di-t-butyl-4-ethylphenol, 2,6-di-t-butyl-4-methylphenol, 4-hydroxymethyl-2,6-di-t-butylphenol, butylhydroxyanisole, 2-(1-methylcyclohexyl)-4,6-dimethylphenol, 2,4-dimethyl-6-t-butylphenol, 2-methyl-4,6-dinonylphenol, 2,6-di-t-butyl-α-dimethylamino-p-cresol, 6-(4-hydroxy-3,5-di-t-butylanilino)-2,4-bis-octyl-thio-1,3,5-triazine, n-octadecyl-3-(4′-hydroxy-3′,5′-di-t-butylphenyl)propionate, octylated phenol, alkyl-substituted phenols, and alkylated-p-cresol; hindered phenols such as Irganox 1010, Irganox 1035, Irganox 1076, Irganox 1098, Irganox 1135, Irganox 1330, Irganox 1520, Irganox 245, Irganox 259, Irganox 3114, and Irganox MD 1024 (all of which are manufactured by BASF SE), AO-20 (manufactured by ADEKA Corporation), and HINDAOX GA80 (manufactured by Sumitomo Chemical Co., Ltd.); bisphenols, trisphenols, and polyphenols, such as 4,4′-dihydroxydiphenyl, methylenebis(dimethyl-4,6-phenol), 2,2′-methylene-bis-(4-methyl-6-t-butylphenol), 2,2′-methylene-bis-(4-methyl-6-cyclohexylphenol), 2,2′-methylene-bis-(4-ethyl-6-t-butylphenol), 4,4′-methylene-bis-(2,6-di-t-butylphenol), and 2,2′-methylene-bis-(6-α-methyl-benzyl-p-cresol); methylene-crosslinked polyhydric alkylphenols such as 4,4′-butylidenebis-(3-methyl-6-t-butylphenol), 1,1-bis-(4-hydroxyphenyl)-cyclohexane, 2,2′-dihydroxy-3,3′-di-(α-methylcyclohexyl)-5,5′-dimethyldiphenylmethane, alkylated bisphenol, hindered bisphenol, 1,3,5-trimethyl-2,4,6-tris(3,5-di-t-butyl-4-hydroxybenzyl)benzene, tris-(2-methyl-4-hydroxy-5-t-butylphenyl)butane, and tetrakis-[methylene-3-(3′,5′-di-t-butyl-4′-hydroxyphenyl)propionate]methane; and the like.

Examples of the amine-based antioxidant include amine-based antioxidants such as 4,4′-bis(α,α-dimethylbenzyl)diphenylamine, N,N′-diphenyl-1,4-phenylenediamine, N,N′-di-2-naphthyl-1,4-phenylenediamine, N,N′-di-sec-butyl-1,4-phenylenediamine, N-(1,3-dimethylbutyl)-N′-phenyl-1,4-phenylenediamine, 6-ethoxy-2,2,4-trimethyl-1,2-dihydroquinoline, N-phenyl-1-naphthylamine, 4-isopropylaminodiphenylamine, and Irganox 565 (manufactured by BASF SE); hindered amines (hindered amine-based antioxidants) such as Adecastab LA (product name, hindered amine-based light stabilizer, manufactured by ADEKA Corporation) series LA-52, LA-57, LA-63P, LA-68, LA-72, LA-77Y, LA-77G, LA-81, LA-82, LA-87, LA-402AF, and LA-502XP, Chimassorb 2020FDL, Chimassorb 944 FDL, Tinuvin 622 SF, Tinuvin P_{A} 144, Tinuvin 765, and Tinuvin 770 DF manufactured by BASF SE, and sebacic acid bis(2,2,6,6-tetramethyl-4-piperidyl-1-oxyl); and the like.

### (Peroxide Decomposing Agent)

The peroxide decomposing agent is a compound that decomposes peroxides generated by exposure to light or the like into harmless substances and prevents new radicals from being generated, and examples thereof include a sulfur-based antioxidant, a phosphorus-based antioxidant, and the like. Among these, from the viewpoint that the stability of the color characteristics is more excellent, a sulfur-based antioxidant is preferable as the peroxide decomposing agent.

Examples of the sulfur-based antioxidant include a thiopropionate-based compound, a mercaptobenzimidazole-based compound, and the like and among these, from the viewpoint that the stability of the color characteristics is more excellent, a thiopropionate-based compound is preferable.

Examples of a commercially available product of the sulfur-based antioxidant include AO-23, AO-412S, and AO-503 manufactured by ADEKA Corporation; CG25-650 manufactured by CIBA-GEIGY AG; Irganox PS 800 and Irganox PS 802 FL manufactured by BASF SE; and the like.

Examples of a commercially available product of the phosphorus-based antioxidant include Irgafos 168 manufactured by BASF SE; MARK 2112, MARK 329K, PEP-36, PEP-24G, PEP-8, and HP-10 manufactured by ADEKA Corporation; HI-M-P manufactured by Sanko Chemical Industry Co., Ltd.; and the like.

### (Ultraviolet Absorber)

Examples of the ultraviolet absorber include a salicylic acid ester-based ultraviolet absorber, a benzophenone-based ultraviolet absorber, a benzotriazole-based ultraviolet absorber, a triazine-based ultraviolet absorber, a benzoate-based ultraviolet absorber, and the like.

### (Singlet Oxygen Quencher)

The singlet oxygen quencher is a compound which can deactivate singlet oxygen through energy transfer from oxygen in a singlet state.

As the singlet oxygen quencher, for example, known compounds such as ethylenic compounds such as tetramethyl ethylene and cyclopentene; secondary amines such as diethylamine; tertiary amines such as triethylamine, 1,4-diazabicyclooctane (DABCO), and N-ethylimidazole; condensed polycyclic aromatic compounds such as substituted or unsubstituted naphthalene (for example, naphthalene, dimethylnaphthalene, and the like) and substituted or unsubstituted anthracene (for example, anthracene, dimethoxyanthracene, diphenylanthracene, and the like); aromatic compounds such as 1,3-diphenylisobenzofuran, 1,2,3,4-tetraphenyl-1,3-cyclopentadiene, and pentaphenylcyclopentadiene; hydroxylamines represented by bis(octadecyl) hydroxylamine, a compound represented by Formula (V) which will be described later, and compounds described in EP0451833A1, JP1993-273716A (JP-H05-273716A), EP0698814A3, JP1996-076311A (JP-H08-076311A), and JP1996-184949A (JP-H08-184949A); hydrazines such as tetraalkylhydrazines and phenidones, which is represented by a compound described in JP2001-342387A; catechol ethers represented by compounds described in JP1982-204036A (JP-S57-204036A), JP1982-204035A (JP-S57-204035A), and JP2005-100672A; and the like can be used.

Hydroxylamines can also act as a radical scavenging agent.

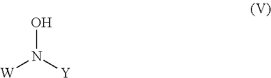

In Formula (V), W represents a hydrogen atom or a methyl group.

Y represents a linear or branched alkyl group having 1 to 30 carbon atoms, in which one or more —CH₂—'s may be substituted with a group selected from the group consisting of —O—, —NH—, and —CO—. Among these, the number of carbon atoms in the alkyl group represented by Y is preferably 5 or more and more preferably 10 or more.

In addition, as the singlet oxygen quencher, for example, those described in Harry H. Wasserman, “Singlet Oxygen”, Chapter 5, Academic Press (1979), Nicholas J. Turro, “Modern Molecular Photochemistry”, Chapter 14, The Benjamin Cummings Publishing Co., Inc. (1978), and High-Function Chemicals for Color Photosensitive Materials, Chapter 7, CMC Co., Ltd. (2002) can also be used.

Examples of the singlet oxygen quencher other than the above-described compound also include a metal complex containing a compound having a sulfur atom as a ligand, and examples thereof include a transition metal chelate compound such as a nickel complex, a cobalt complex, a copper complex, a manganese complex, a platinum complex, and the like, containing a compound selected from the group consisting of bisdithio-α-diketone, bisphenyldithiol, and thiobisphenol.

As the singlet oxygen quencher, from the viewpoint of more excellent effect of the present invention, hydroxylamines are preferable, and a compound represented by Formula (V) is more preferable.

### (Oil-Soluble Antioxidant)

Examples of the oil-soluble antioxidant include a vitamin E compound, ascorbic acids, and the like. As the oil-soluble antioxidant, in addition to the above-described compounds, for example, various antioxidants described in “Theory and practice of antioxidants” (written by Kajimoto, San Shobo, 1984); various antioxidants described in “Handbook of antioxidants” (written by Saruwatari, Nishino, and Tabata, Taiseisha, 1976); a compound among carotenoids other than lycopene, in which the solubility in water at 25° C. is less than 0.3% by mass (less than 3 g/L); and the like can be used.

Specific examples of the vitamin E compound include tocopherols, tocotrienols, and the like.

Examples of the tocopherols include d-α-tocopherol, d-β-tocopherol, d-γ-tocopherol, d-σ-tocopherol, dl-α-tocopherol, d-α-tocopherol acetate, dl-α-tocopherol acetate, and the like.

Examples of the ascorbic acids include L-ascorbic acid palmitic acid ester, L-ascorbic acid stearic acid ester, and the like.

From the viewpoint of more excellent effect of the present invention, the antioxidant preferably includes one or more selected from the group consisting of tertiary amines, hydroxylamines, tocopherols, catechol ethers, hindered phenols, and hindered amines, more preferably includes one or more selected from the group consisting of hydroxylamines, hindered phenols, and hindered amines, and still more preferably includes hydroxylamines.

In the liquid crystalline composition, the antioxidant may be used alone or in combination of two or more types.

In a case where the compound A exhibits liquid crystallinity and the liquid crystalline composition does not contain the liquid crystal compound B (in a case where the liquid crystalline composition is the liquid crystalline composition according to the first aspect), the content of the antioxidant is preferably 0.01% to 5% by mass, more preferably 0.1% to 4% by mass, and still more preferably 0.5% to 3% by mass with respect to the content of the compound A.

In a case where the liquid crystalline composition contains the liquid crystal compound B (in a case where the liquid crystalline composition is a liquid crystalline composition according to the second aspect or the third aspect), the content of the antioxidant is preferably 0.01% to 5% by mass, more preferably 0.1% to 4% by mass, and still more preferably 0.5% to 3% by mass with respect to the total content of the compound A and the liquid crystal compound B.

### <Polymerization Initiator>

The liquid crystalline composition preferably contains a polymerization initiator.

The polymerization initiator is preferably a photopolymerization initiator capable of initiating a polymerization reaction by ultraviolet irradiation. Examples of the photopolymerization initiator include α-carbonyl compounds (described in each of U.S. Pat. Nos. 2,367,661A and 2,367,670A), acyloin ethers (described in U.S. Pat. No. 2,448,828A), α-hydrocarbon substituted aromatic acyloin compounds (described in U.S. Pat. No. 2,722,512A), polynuclear quinone compounds (described in each of U.S. Pat. Nos. 3,046,127A and 2,951,758A), combinations of triarylimidazole dimers and p-aminophenyl ketones (described in U.S. Pat. No. 3,549,367A), acridine and phenazine compounds (described in JP1985-105667A (JP-S60-105667A) and U.S. Pat. No. 4,239,850A), oxadiazole compounds (described in U.S. Pat. No. 4,212,970A), and acylphosphine oxide compounds (described in JP1988-040799B (JP-S63-040799B), JP1993-029234B (JP-H5-029234B), JP1998-95788A (JP-H10-95788A), and JP1998-29997A (JP-H10-29997A).

Among these, the polymerization initiator is preferably an α-carbonyl compound or an acylphosphine oxide compound, and more preferably an acylphosphine oxide compound.

In a case where the liquid crystalline composition contains a polymerization initiator, a content of the polymerization initiator in the liquid crystalline composition is preferably 0.1% to 20% by mass and more preferably 1% to 10% by mass with respect to the content of the liquid crystal compound contained in the liquid crystalline composition.

In the liquid crystalline composition, the polymerization initiator may be used alone or in combination of two or more types. In a case where two or more types are used, the total content thereof is preferably within the above-described range.

### <Surfactant>

The liquid crystalline composition may contain a surfactant which contributes to stable or rapid formation of a liquid crystal phase.

Examples of the surfactant include a fluorine-containing (meth)acrylate-based polymer, compounds represented by General Formulae (X1) to (X3) described in WO2011/162291A, compounds represented by General Formula (I) described in paragraphs [0082] to [0090] of JP2014-119605A, and compounds described in paragraphs [0020] to [0031] of JP2013-047204A. At an air interface of a layer, these compounds can reduce a tilt angle of molecules of a liquid crystal compound or can cause a liquid crystal compound to be substantially horizontally aligned.

In the present specification, “horizontal alignment” means that the molecular axis of the liquid crystal compound (in a case where the liquid crystal compound is a rod-like liquid crystal compound, corresponding to a long axis of the liquid crystal compound) and the film surface are parallel to each other, but it is not required to be strictly parallel. In the present specification, “horizontal alignment” means an alignment in which the tilt angle formed with the film surface is less than 20 degrees. In a case where the liquid crystal compound is horizontally aligned near the air interface, alignment defects are less likely to occur, so that transparency in a visible light region is increased. On the other hand, in a case where the molecules of the liquid crystal compound are aligned at a large tilt angle, for example, in a case of cholesteric phase, since a spiral axis thereof deviates from a normal line of the film surface, reflectivity may decrease, fingerprint patterns may occur, or haze may increase or diffractivity may be exhibited, which are not preferable.

Examples of the fluorine-containing (meth)acrylate-based polymer that can be used as a surfactant also include polymers disclosed in paragraphs [0018] to [0043] of JP2007-272185A.

In a case where the liquid crystalline composition contains a surfactant, the content of the surfactant in the liquid crystalline composition is not particularly limited, but is preferably 0.001% to 10% by mass and more preferably 0.05% to 3% by mass with respect to the total mass of the liquid crystal compound contained in the liquid crystalline composition.

In the liquid crystal composition, the surfactant may be used alone or in combination of two or more types thereof. In a case where two or more types are used, the total content thereof is preferably within the above-described range.

### <Solvent>

The liquid crystalline composition may contain a solvent.

The solvent is preferably a solvent capable of dissolving each component formulated in the liquid crystalline composition, and examples thereof include ketones (for example, acetone, 2-butanone, methyl ethyl ketone, methyl isobutyl ketone, cyclohexanone, cyclopentanone, and the like), ethers (for example, dioxane, tetrahydrofuran, and the like), aliphatic hydrocarbons (for example, hexane and the like), alicyclic hydrocarbons (for example, cyclohexane and the like), aromatic hydrocarbons (for example, toluene, xylene, trimethylbenzene, and the like), halogenated carbons (dichloromethane, dichloroethane, dichlorobenzene, chlorotoluene, and the like), esters (for example, methyl acetate, ethyl acetate, butyl acetate, and the like), water, alcohols (for example, ethanol, isopropanol, butanol, cyclohexanol, and the like), cellosolves (for example, methyl cellosolve, ethyl cellosolve, and the like), cellosolve acetates, sulfoxides (for example, dimethyl sulfoxide and the like), and amides (for example, dimethylformamide, dimethylacetamide, and the like), and the like.

In a case where the liquid crystalline composition contains a solvent, the content of the solvent in the liquid crystalline composition is preferably 0.5% to 30% by mass and more preferably 1% to 20% by mass, as the concentration of solid contents.

In the liquid crystalline composition, the solvent may be used alone or in combination of two or more types thereof. In a case where two or more types are used, the total content thereof is preferably within the above-described range.

### (Chiral Agent)

The liquid crystalline composition may contain a chiral agent.

The chiral agent (optically active compound) has a function of causing a helical structure of a cholesteric liquid crystalline phase to be formed. The chiral agent may be selected according to the purpose since the induced helical twisted direction or helical pitch varies depending on the compound.

The chiral agent is not particularly limited, and for example, a compound described in “Liquid Crystal Device Handbook, Chapter 3, Article 4-3, chiral agent for twisted nematic (TN) or super twisted nematic (STN), p. 199, edited by No. 142 Committee of Japan Society for the Promotion of Science, 1989”, isosorbide, an isomannide derivative, and the like can be used.

The chiral agent generally contains an asymmetric carbon atom, but an axially chiral compound or a planar chiral compound containing no asymmetric carbon atom can also be used as the chiral agent. Examples of the axially chiral compound or the planar chiral compound include binaphthyl, helicene, paracyclophane, and derivatives thereof.

In addition, the chiral agent may include a polymerizable group. In a case where both the chiral agent and the liquid crystal compound contain polymerizable groups, a polymer that includes a repeating unit derived from a polymerizable liquid crystal compound and a repeating unit derived from the chiral agent can be formed by a polymerization reaction of a polymerizable chiral agent and the polymerizable liquid crystal compound. In this aspect, the polymerizable group contained in the polymerizable chiral agent is preferably the same group as the polymerizable group contained in the polymerizable liquid crystal compound.

Furthermore, the chiral agent itself may be the liquid crystal compound.

In a case where the chiral agent has a photoisomerization group, a pattern having a desired reflection wavelength corresponding to a luminescence wavelength can be formed by irradiation with actinic ray or the like through a photo mask after coating and alignment, which is preferable. As the photoisomerization group, an isomerization site of a compound exhibiting photochromic properties, an azo group, an azoxy group, or a cinnamoyl group is preferable. Specific examples of the compound include compounds described in JP2002-080478A, JP2002-080851A, JP2002-179668A, JP2002-179669A, JP2002-179670A, JP2002-179681A, JP2002-179682A, JP2002-338575A, JP2002-338668A, JP2003-313189A, JP2003-313292A, and the like.

In a case where the liquid crystalline composition contains a chiral agent, the content of the chiral agent in the liquid crystalline composition is not particularly limited, but is preferably 0.01% to 15% by mass and more preferably 1.0% to 10% by mass with respect to the content of the liquid crystal compound.

### <Other Additives>

The liquid crystalline composition may contain other additives in addition to the above-described components.

Examples of the other additives include an antioxidant, an ultraviolet absorber, a sensitizer, a stabilizer, a plasticizer, a chain transfer agent, a polymerization inhibitor, an antifoaming agent, a leveling agent, a thickener, a flame retardant, a surfactant, a dispersant, and a color material such as a dye and a pigment.

### <Δn of Liquid Crystalline Composition>

From the viewpoint that the diffraction efficiency of the film to be obtained is further increased, in the refractive index anisotropy Δn of the liquid crystalline composition, Δn at a wavelength of 550 nm is preferably 0.21 or more, more preferably 0.25 or more, still more preferably 0.28 or more, and particularly preferably 0.30 or more. The upper limit value is not particularly limited, but for example, is preferably 0.80 or less.

In addition, the refractive index anisotropy Δn of the liquid crystalline composition can be measured by the following method. In a case where the liquid crystalline composition contains a solvent as follows, the solvent is removed from the liquid crystalline composition, and Δn is measured.

### (Method for Measuring Δn)

Δn of each liquid crystalline composition is measured by a method using a wedge-shaped liquid crystal cell, which is described on page 202 of Liquid Crystal Handbook (edited by the Liquid Crystal Handbook Editorial Committee, published by MARUZEN CO., LTD.). In a case where the liquid crystalline composition contains a solvent, the liquid crystalline composition is dried on a hot plate at 120° C. in advance, and the composition obtained by removing the solvent is used to measure Δn.

### [Application of Liquid Crystalline Composition]

The cured product formed from the liquid crystalline composition can be used as an optically anisotropic layer.

Hereinafter, the optically anisotropic layer and a manufacturing method thereof will be described.

### <<Example of Embodiment of Optically Anisotropic Layer>>

An example of an embodiment of the optically anisotropic layer consisting of the cured layer of the above-described liquid crystalline composition will be described with reference to the drawings.

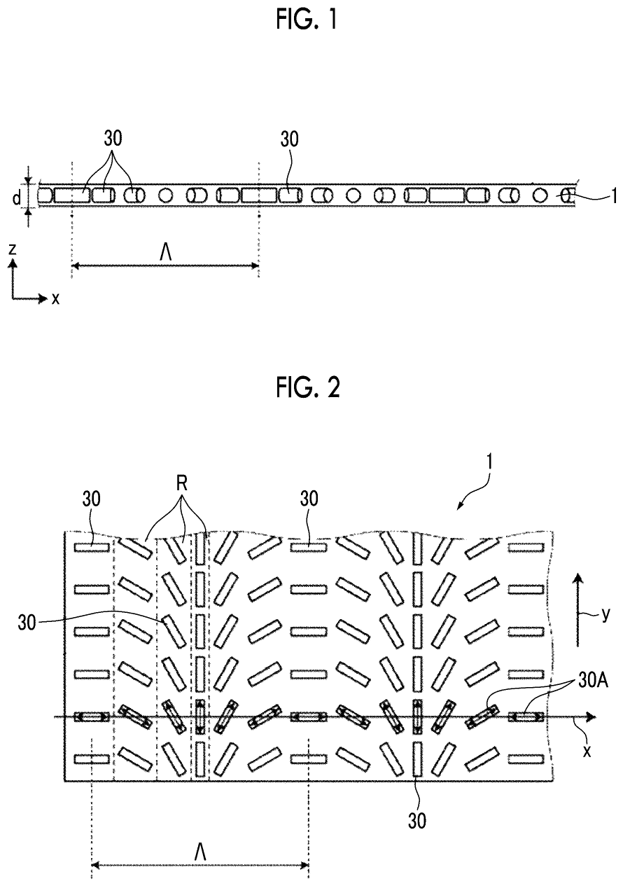

FIGS. 1 and 2 are schematic cross-sectional views of the optically anisotropic layer 1. FIG. 1 is a schematic side view showing the optically anisotropic layer 1, and FIG. 2 is a schematic plan view showing a liquid crystal alignment pattern of the optically anisotropic layer 1 shown in FIG. 1. In the drawings, a sheet surface of the sheet-like optically anisotropic layer 1 is defined as an xy plane, and a thickness direction is defined as a z direction.

As shown in FIG. 1, the optically anisotropic layer 1 has a liquid crystal alignment pattern (length A of one period) in which an orientation of an optical axis derived from the liquid crystal compound 30 is changed while continuously rotating along at least one in-plane direction.

In FIGS. 1 to 4, only the liquid crystal molecules present on one main surface side of the optically anisotropic layer 1 are shown in order to simplify the drawings and clearly show the configuration of the optically anisotropic layer 1. However, the optically anisotropic layer 1 has a structure in which the aligned liquid crystal compounds 30 are laminated same as in an optically anisotropic layer which is formed using a composition including a normal liquid crystal compound.

Typically, in a case where a value of an in-plane retardation is set as 2/2, the optically anisotropic layer 1 has a function as a general 2/2 plate, that is, a function of imparting a phase difference of a half wavelength, that is, 180° to two linearly polarized light components which are included in light incident into the optically-anisotropic layer and are perpendicular to each other.

As shown in FIG. 2, in a plane of the optically anisotropic layer 1, the optically anisotropic layer 1 has a liquid crystal alignment pattern in which an orientation of an optical axis 30A (hereinafter, may be also referred to as “optical axis 30A”) derived from the liquid crystal compound 30 is changed while continuously rotating in one direction. Here, the one direction in which the optical axis 30A is changed while rotating is set coincidental with a direction of an x-axis in the xy plane. Hereinafter, the one direction in which the optical axis 30A is changed while rotating will be described as an x direction.

The optical axis 30A derived from the liquid crystal compound 30 is an axis having the highest refractive index in the liquid crystal compound 30, that is, a so-called slow axis. As shown in FIG. 1, in a case where the liquid crystal compound 30 is a rod-like liquid crystal compound, the optical axis 30A is along a rod-shaped major axis direction.

Specifically, changing the orientation of the optical axis 30A while continuously rotating along the x direction means that an angle between the optical axis 30A of the liquid crystal compound 30, which is arranged along the x direction, and the x direction varies depending on positions in the x direction, and the angle between the optical axis 30A and the x direction is gradually changed from θ to θ+180° or θ−180° in the x direction. Here, the expression “the angle gradually is changed” means that the angle may be changed at constant angular intervals, or may be changed continuously. However, a difference between the angles of the optical axes 30A of the liquid crystal compound 30 adjacent to each other in the x direction is preferably 45° or less, more preferably 15° or less, and still more preferably less than 15°.

On the other hand, regarding the liquid crystal compound 30 forming the optically anisotropic layer 1, the liquid crystal compounds 30 having the same orientation of the optical axes 30A are arranged at regular intervals in a y direction perpendicular to the x direction in a plane, that is, a y direction perpendicular to the one direction (x direction) in which the optical axis 30A continuously rotates. In other words, regarding the liquid crystal compound 30 forming the optically anisotropic layer 1, in the liquid crystal compounds 30 arranged in the y direction, angles between the orientation of the optical axis 30A and the x direction are the same. In the optically anisotropic layer 1, in such a liquid crystal alignment pattern of the liquid crystal compound 30, the length (distance) over which the optical axis 30A of the liquid crystal compound 30 rotates by 180° in the x direction along which the orientation of the optical axis 30A is changed while continuously rotating in the plane is defined as a length A of the single period in the liquid crystal alignment pattern. In other words, the length of the single period in the liquid crystal alignment pattern is defined as the distance between θ and θ+180° that is a range of the angle between the optical axis 30A of the liquid crystal compound 30 and the x direction. Specifically, as shown in FIG. 2, a distance of centers in the x direction of two liquid crystal compounds 30 in which the x direction and the direction of the optical axis 30A match each other is defined as the length A of the single period (hereinafter, may be also referred to as “one period Λ” or “period Λ”). The liquid crystal alignment pattern of the optically anisotropic layer 1 is a pattern in which the liquid crystal alignment of this single period Λ is repeated in the x direction.

As described above, in the optically anisotropic layer 1, in the liquid crystal compounds 30 arranged in the y direction, the angles between the optical axes 30A thereof and the x direction in which the orientation of the optical axis of the liquid crystal compound 30 rotates are the same. Regions where the liquid crystal compounds 30 in which the angles between the optical axes 30A and the x direction are the same are arranged in the y direction will be referred to as “regions R”.

In this case, a value of the in-plane retardation (Re) in each region R is a half wavelength of light (hereinafter, referred to as a “target light”) to be diffracted by the optically anisotropic layer, that is, in a case where a wavelength of the target light is 2, the in-plane retardation Re is preferably λ/2. The in-plane retardation is calculated from the product of a refractive index anisotropy Δn of the regions R and the thickness (film thickness) d of the optically anisotropic layer. Here, the difference in refractive index generated by refractive index anisotropy of the region R in the optically anisotropic layer is defined by a difference between a refractive index of a direction of an in-plane slow axis of the region R and a refractive index of a direction orthogonal to the direction of the slow axis. That is, the difference Δn in refractive index generated by refractive index anisotropy of the region R is the same as a difference between a refractive index of the liquid crystal compound 30 in the direction of the optical axis 30A and a refractive index of the liquid crystal compound 30 in a direction perpendicular to the optical axis 30A in a plane of the region R. That is, the above-described difference Δn in refractive index depends on the liquid crystal compound, and the in-plane retardation of each region R is substantially the same. However, as described above, each region R has a different direction of the optical axis 30A.

In the optically anisotropic layer 1, since the orientation of the optical axis 30A rotates in the plane, it is difficult to measure the in-plane retardation as a whole. However, the in-plane retardation of the optically anisotropic layer 1 can be estimated from the period and the diffraction efficiency.

In a case where circularly polarized light is incident into such an optically anisotropic layer 1, the light is refracted such that the direction of the circularly polarized light is converted.

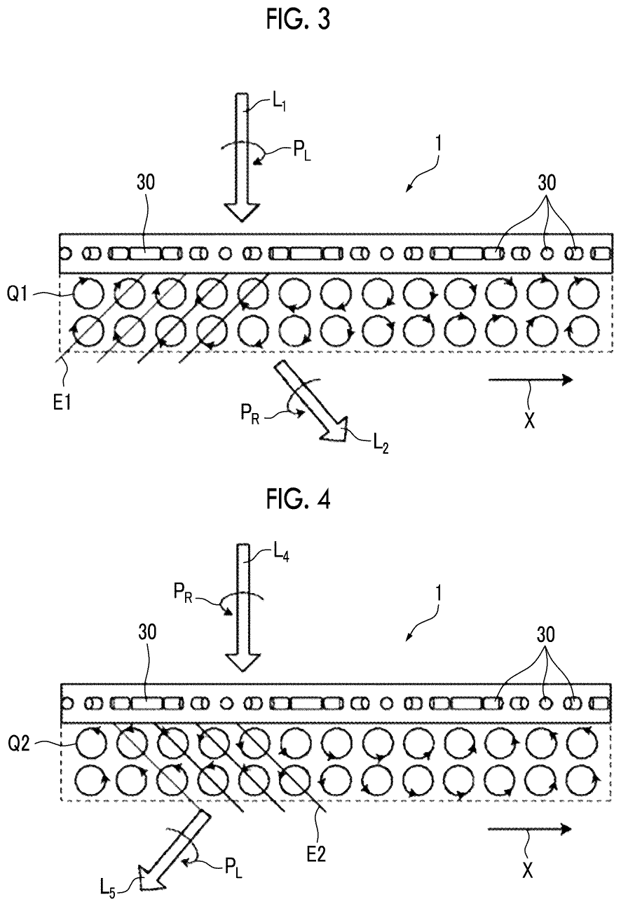

This action is conceptually shown in FIG. 3 using the optically anisotropic layer 1 as an example. It is assumed that the in-plane retardation of the optically anisotropic layer 1 is λ/2.

In this case, as shown in FIG. 3, in a case where an incidence light L₁ as levorotatory circularly polarized light P_{L} is incident into the optically anisotropic layer 1, the incidence light L₁ transmits through the optically anisotropic layer 1 to be given a phase difference of 180°, thereby a transmitted light L₂ is converted into dextrorotatory circularly polarized light P_{R}.

In addition, in a case where the incidence light L₁ transmits through the optically anisotropic layer 1, an absolute phase thereof changes depending on the orientation of the optical axis 30A of each of the liquid crystal compounds 30. At this time, since the orientation of the optical axis 30A changes while rotating in the x direction, the amount of change in absolute phase of the incidence light L₁ varies depending on the orientation of the optical axis 30A. Furthermore, the liquid crystal alignment pattern formed in the optically anisotropic layer 1 is a pattern which is periodic in the x direction. Therefore, as shown in FIG. 3, the incidence light L₁ transmitted through the optically anisotropic layer 1 is imparted with an absolute phase Q1 which is periodic in the x direction corresponding to the orientation of each optical axis 30A. As a result, an equiphase surface E1 which is tilted in a direction opposite to the x direction is formed.

Therefore, the transmitted light L₂ is refracted to be tilted in a direction perpendicular to the equiphase surface E1 and travels in a direction different from a traveling direction of the incidence light L₁. In this way, the incidence light L₁ of the levorotatory circularly polarized light P_{L} is converted into the transmitted light L₂ of the dextrorotatory circularly polarized light P_{R} which is tilted by a predetermined angle in the x direction with respect to an incidence direction.

On the other hand, as conceptually shown in FIG. 4, in a case where an incidence light L₄ of dextrorotatory circularly polarized light P_{R} is incident into the optically anisotropic layer 1 having the same in-plane retardation, the incidence light L₄ transmits through the optically anisotropic layer 1 to be given a phase difference of 180°, thereby the incidence light L₄ is converted into a transmitted light L₅ of levorotatory circularly polarized light P_{L}.

In addition, in a case where the incidence light L₄ transmits through the optically anisotropic layer 1, an absolute phase thereof changes depending on the orientation of the optical axis 30A of each of the liquid crystal compounds 30. At this time, since the orientation of the optical axis 30A changes while rotating in the x direction, the amount of change in absolute phase of the incidence light L₄ varies depending on the orientation of the optical axis 30A. Furthermore, the liquid crystal alignment pattern formed in the optically anisotropic layer 1 is a pattern which is periodic in the x direction. Therefore, as shown in FIG. 4, the incidence light L₄ transmitted through the optically anisotropic layer 1 is imparted with an absolute phase Q² which is periodic in the x direction corresponding to the orientation of each optical axis 30A.

Here, the incidence light L₄ is dextrorotatory circularly polarized light P_{R}. Therefore, the absolute phase Q² which is periodic in the x direction corresponding to the orientation of the optical axis 30A is opposite to the incidence light L₁ as levorotatory circularly polarized light P_{L}. As a result, in the incidence light L₄, an equiphase surface E² which is tilted in the x direction opposite to that of the incidence light L₁ is formed.

Therefore, the incidence light L₄ is refracted to be tilted in a direction perpendicular to the equiphase surface E² and travels in a direction different from a traveling direction of the incidence light L₄. In this way, the incidence light L₄ is converted into the transmitted light L₅ of levorotatory circularly polarized light which is tilted by a predetermined angle in a direction opposite to the x direction with respect to an incidence direction.

As described above, in the optically anisotropic layer 1, the value of the in-plane retardation is preferably half the wavelength of the target light. This is because that, as the value of the in-plane retardation is closer to the half wavelength of the target light, high diffraction efficiency can be obtained in the diffraction of the target light. The in-plane retardation Re(λ)=Δn_{λ}×d of the optically anisotropic layer with respect to incidence light having a wavelength in the x direction of λ nm is preferably within a range defined by the following expression and can be appropriately set.

$$0.7 \times ( λ / 2 ) nm \leq Δ {n}_{λ} \times d \leq 1.3 \times ( λ / 2 ) nm$$

Here, by changing the single period Λ of the liquid crystal alignment pattern formed in the optically anisotropic layer 1, refraction angles of the transmitted light components L₂ and L₅ can be adjusted. Specifically, as the single period Λ of the liquid crystal alignment pattern decreases, light components transmitted through the liquid crystal compounds 30 adjacent to each other more strongly interfere with each other. Therefore, the transmitted light components L₂ and L₅ can be more largely refracted. Furthermore, by reversing a rotation direction of the optical axis 30A of the liquid crystal compound 30 which rotates in the x direction, a refraction direction of the transmitted light can be reversed. The period Λ is preferably 50 μm or less, more preferably 25 μm or less, and still more preferably 5 μm or less.

It is sufficient that the film thickness d of the optically-anisotropic layer 1 is appropriately set in order to obtain a desired in-plane retardation, but the film thickness d is preferably 1 μm or less, more preferably 0.8 μm or less, and still more preferably 0.5 μm or less. In particular, in a case where the optically anisotropic layer 1 is used as a birefringent mask for forming a photo-alignment pattern, a smaller film thickness d is preferable. As the film thickness d is smaller, a formation accuracy of the photo-alignment pattern can be improved.

The ratio Λ/d of the period Λ to the film thickness d of the optically-anisotropic layer is preferably 1 or more.

The period Λ of the liquid crystal alignment pattern in the optically-anisotropic layer 1 is obtained from a period of light and dark by observing bright and dark period pattern of bright portions and dark portions with a polarizing microscope under a condition of crossed nicols. Twice the period of the observed bright and dark period pattern corresponds to the period Λ of the liquid crystal alignment pattern.

In addition, the film thickness d of the optically-anisotropic layer 1 can be measured by, for example, observing a cross section of the optically-anisotropic layer with a scanning electron microscope.

In the optically anisotropic layer 1, the refractive index anisotropy Δn at a wavelength of 550 nm is preferably 0.21 or more. The upper limit is not particularly limited, and is preferably 0.8 or less.

In addition, it is also preferable that the optically-anisotropic layer can be made to have a substantially wide range for the wavelength of incidence light by imparting a twist component to the liquid crystal composition or by laminating different retardation layers. For example, in the optically anisotropic layer, a method of realizing a λ/2 plate having a wide-range pattern by laminating two liquid crystal layers having different twisted directions is disclosed in, for example, JP2014-089476A and can be suitably used in the optically anisotropic layer according to the embodiment of the present invention.

### <Method for Producing Optically Anisotropic Layer 1>

Specific examples of the method for producing the optically anisotropic layer 1 include an aspect in which a step X of bringing a substrate including an alignment film having a predetermined alignment pattern into contact with a liquid crystalline composition to form a composition layer on the alignment film on the substrate, and a step Y of subjecting the composition layer to a heat treatment to align the liquid crystal compound, and then subjecting the same to a curing treatment are included.

After the production of the optically anisotropic layer 1, the above-described substrate may be removed from the optically anisotropic layer, or may not be removed. In addition, in the same manner, the above-described alignment film may be removed from the optically anisotropic layer after the production of the optically anisotropic layer 1, or may not be removed.

In addition, the above-described substrate may be an oxygen barrier layer (for example, a glass substrate and the like), which will be described later.

Hereinafter, specific procedures for the step X and the step Y will be described in detail.

### (Step X)

### Substrate

In the step X, the type of the substrate to be used is not particularly limited, and examples thereof include known substrates (for example, a resin substrate, a glass substrate, a ceramic substrate, a semiconductor substrate, and a metal substrate).

### Alignment Film

An alignment film is disposed on the substrate. In a case where the alignment film is present, the liquid crystal compound 30 is easily aligned in a predetermined liquid crystal alignment pattern in the production of the optically anisotropic layer 1. As described above, the optically anisotropic layer 1 has a liquid crystal alignment pattern in which the orientation of the optical axis 30A (see FIG. 2) derived from the liquid crystal compound 30 is changed while continuously rotating along one in-plane direction (x direction). Therefore, the alignment film is formed such that the optically anisotropic layer can form the liquid crystal alignment pattern.

Various known alignment films can be used. Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as @-tricosanoic acid, dioctadecylmethylammonium chloride, or methyl stearate.

The alignment film by the rubbing treatment can be formed by rubbing the surface of the polymer layer several times in a certain direction with paper or cloth.

As the material used for the alignment film, polyimide, polyvinyl alcohol, a polymer having a polymerizable group described in JP1997-152509A (JP-H9-152509A), and a material used for forming an alignment film described in JP2005-097377A, JP2005-099228A, JP2005-128503A, and the like, can be suitably used.

In addition, as the alignment film, a so-called photo-alignment film obtained by irradiating a photo-alignment material with polarized or non-polarized light to form an alignment film can be suitably used. In a case of being irradiated with polarized light to form the alignment film, the alignment film can be formed by irradiating the photo-alignment material with polarized light from a vertical direction or an oblique direction, and in a case of being irradiated with non-polarized light to obtain the alignment film, the alignment film can be formed by irradiating the photo-alignment material with non-polarized light from an oblique direction.

Examples of the photo-alignment material used in the photo-alignment film include an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B, an aromatic ester compound described in JP2002-229039A, a maleimide- and/or alkenyl-substituted nadiimide compound having a photo-alignable unit described in JP2002-265541A and JP2002-317013A, a photocrosslinking silane derivative described in JP4205195B and JP4205198B, a photocrosslinking polyimide, a photocrosslinking polyamide, and a photocrosslinking ester described in JP2003-520878A, JP2004-529220A, and JP4162850B, and a photodimerizable compound, in particular, a cinnamate compound, a chalcone compound, a coumarin compound, and the like described in JP1997-118717A (JP-H9-118717A), JP1998-506420A (JP-H10-506420A), JP2003-505561A, WO2010/150748A, JP2013-177561A, and JP2014-12823A. Among these, an azo compound, a photocrosslinking polyimide, a photocrosslinking polyamide, a photocrosslinking ester, a cinnamate compound, a chalcone compound, or the like can be suitably used.

The thickness of the alignment film is not particularly limited and may be appropriately set according to the material for forming the alignment film such that a required alignment function can be obtained.

The thickness of the alignment film is preferably 0.01 to 5 μm and more preferably 0.05 to 2 μm.

The method of forming the alignment film is not particularly limited, and various known methods can be used according to the material for forming the alignment film.

From the viewpoint that the alignment pattern of the optically anisotropic layer 1 is more easily formed, a photo-alignment film is preferable, which is obtained by irradiating the photo-alignment material with polarized or non-polarized light to form an alignment film. A

method described in to of WO2020/022496A can be suitably applied.

### Procedure of Step X

A method of bringing a substrate including an alignment film having a predetermined alignment pattern (hereinafter, also referred to as “substrate with an alignment film”) into contact with the liquid crystalline composition is not particularly limited, and examples thereof include a method of applying the composition onto the alignment film on the substrate and a method of immersing the above-described substrate with the alignment film in the composition.

After the substrate with an alignment film is brought into contact with the composition, a drying treatment may be performed as necessary to remove a solvent from the composition layer disposed on the alignment film on the substrate.

### (Step Y)

The step Y is a step of subjecting the composition layer to a heat treatment to align the liquid crystal compound, and then subjecting the same to a curing treatment. By subjecting the composition layer to a heat treatment, the liquid crystal compound is aligned to form a liquid crystal phase. For example, in a case where the composition layer contains a chiral agent, a cholesteric liquid crystalline phase is formed.

Conditions of the heat treatment are not particularly limited, and optimum conditions are selected depending on the type of the liquid crystal compound.

The method of the curing treatment is not particularly limited, and examples thereof include photo-curing treatment and thermosetting treatment. Above all, a light irradiation treatment is preferable, and an ultraviolet irradiation treatment is more preferable.

A light source such as an ultraviolet lamp is used for ultraviolet irradiation.

The cured product that is obtained by the above treatment corresponds to a layer that is obtained by immobilizing a liquid crystal phase. In particular, in a case where the liquid crystalline composition contains a chiral agent, a layer is formed in which a cholesteric liquid crystalline phase is immobilized.

These layers do not need to exhibit liquid crystallinity anymore. More specifically, for example, as a state in which the cholesteric liquid crystalline phase is “immobilized,” the most typical and preferred aspect is a state in which the alignment of the liquid crystal compound, which is the cholesteric liquid crystalline phase, is retained. More specifically, it is preferably a state in which within a temperature range of usually 0° C. to 50° C., or −30° C. to 70° C. under the more severe conditions, no fluidity is exhibited in the layer, no changes in alignment form occur due to an external field or an external force, and a fixed alignment form can be kept stably and continuously.

### <<Modification Example of Optically Anisotropic Layer>>

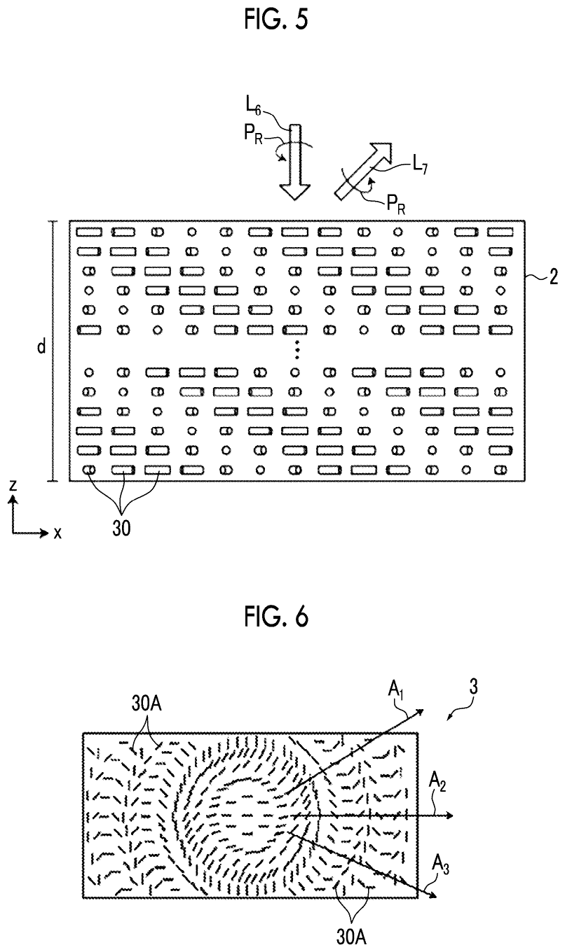

The optically anisotropic layer 2 shown in FIG. 5 is an optically anisotropic layer in which the liquid crystal compound 30 is cholesterically aligned in a thickness direction.

It is known that a cholesteric liquid crystalline phase exhibits selective reflectivity at a specific wavelength. The center wavelength λ of selective reflection (selective reflection center wavelength λ) depends on a pitch P (=helical period) of a helical structure in the cholesteric liquid crystalline phase and satisfies a relationship of λ=n×P with an average refractive index n of the cholesteric liquid crystalline phase. Therefore, the selective reflection center wavelength can be adjusted by adjusting the pitch of the helical structure.

The cholesteric liquid crystalline phase exhibits selective reflectivity with respect to either levorotatory or dextrorotatory circularly polarized light at a specific wavelength. Whether the reflected light is dextrorotatory circularly polarized light or levorotatory circularly polarized light depends on the twisted direction (sense) of the helix of the cholesteric liquid crystalline phase. Regarding the selective reflection of circularly polarized light by the cholesteric liquid crystalline phase, dextrorotatory circularly polarized light is reflected in a case where the helical twisted direction of the cholesteric liquid crystalline phase is right, and levorotatory circularly polarized light is reflected in a case where the helical twisted direction is left.

In addition, a half-width Δλ (nm) of a selective reflection range (circularly polarized light reflection range) where selective reflection is exhibited depends on Δn of the cholesteric liquid crystalline phase and the helical pitch P and complies with a relationship of Δλ=Δn×P. Therefore, the width of the selective reflection range can be controlled by adjusting Δn.

That is, the optically anisotropic layer 2 exhibits a function of selectively reflecting light in a predetermined wavelength range in specific circularly polarized light (dextrorotatory circularly polarized light or levorotatory circularly polarized light).

On the other hand, since the alignment pattern of the optical axis 30A in the in-plane direction of the optically anisotropic layer 2 is the same as the alignment pattern in the optically anisotropic layer 1 shown in FIG. 1, the same effect as the optically anisotropic layer 1 is exhibited. That is, the optically anisotropic layer 2 has the same action as the optically anisotropic layer 1 described above, of changing the absolute phase of the incident light and bending the light in a predetermined direction. Therefore, the optically anisotropic layer 2 has both the action of bending the incidence light to a direction different from the incidence direction and the action of the above-described cholesteric alignment, and reflects light at an angle in a predetermined direction with respect to the reflection direction of specular reflection.

For example, the optically anisotropic layer 2 is designed such that the cholesteric liquid crystalline phase of the optically anisotropic layer 2 reflects dextrorotatory circularly polarized light. In this case, as shown in FIG. 5, in a case where light L₆ which is dextrorotatory circularly polarized light P_{R} is vertically incident into the main surface of the optically anisotropic layer 2, that is, along the normal line, reflected light L₇ which travels in a direction having a tilt with respect to the normal direction is generated. That is, the optically anisotropic layer 2 functions as a reflective type diffraction grating.

In the liquid crystal alignment pattern of the optically anisotropic layer shown in FIGS. 1 to 5, the optical axes 30A of the liquid crystal compound 30 continuously rotate only along the x direction in the plane.

However, in the optically anisotropic layer according to the embodiment of the present invention, various configurations can be used as long as the optical axis 30A of the liquid crystal compound 30 continuously rotates along one direction.

FIG. 6 is a schematic plan view of the optically anisotropic layer 3 of the design change example. In FIG. 6, the liquid crystal alignment pattern is shown by the optical axis 30A of the liquid crystal compound. The optically anisotropic layer 3 has a liquid crystal alignment pattern that regions in which the optical axes 30A have the same orientation are provided concentrically, and that the one direction in which the orientation of optical axis 30A is changed while continuously rotating is provided radially from the center of the optically anisotropic layer 3.

In the optically anisotropic layer 3, the orientations of the optical axes 30A are changed while continuously rotating along a large number of directions from the center of the optically anisotropic layer 3 toward the outside, for example, a direction indicated by an arrow A₁, a direction indicated by an arrow A₂, a direction indicated by an arrow A₃, and the like.

In circularly polarized light incident into the optically anisotropic layer 3 having the above-described liquid crystal alignment pattern, an absolute phase changes depending on individual local regions having different orientations of optical axes of the liquid crystal compound 30. In this case, the amount of change in absolute phase in each of the local regions varies depending on the orientations of the optical axes of the liquid crystal compound 30 into which circularly polarized light is incident.

This way, in the optically anisotropic layer 3 having the concentric circular liquid crystal alignment pattern, that is, the liquid crystal alignment pattern in which the optical axis changes while continuously rotating in a radial shape, transmission of incidence light can be allowed as diverging light or converging light depending on the rotation direction of the optical axis of the liquid crystal compound 30 and the direction of circularly polarized light to be incident.

That is, by setting the liquid crystal alignment pattern of the optically anisotropic layer in a concentric circular shape, the optically anisotropic layer exhibits, for example, a function as a convex lens or a concave lens.

Here, in a case where the liquid crystal alignment pattern of the optically anisotropic layer is concentric circular such that the optically anisotropic layer functions as a convex lens, it is preferable that the length of the single period Λ over which the optical axis rotates 180° in the liquid crystal alignment pattern gradually decreases from the center of the optically anisotropic layer 3 toward the outer direction of the one direction in which the optical axis continuously rotates. The refraction angle of light with respect to an incidence direction increases as the length of the single period Λ in the liquid crystal alignment pattern decreases. Therefore, the light focusing power of the optically anisotropic layer 3 can be further improved and the performance as a convex lens can be improved by gradually shortening the single period Λ in the liquid crystal alignment pattern from the center of the optically anisotropic layer 3 toward the outer direction of the one direction in which the optical axis continuously rotates.

In addition, depending on the uses of the laminate such as a concave lens, it is preferable that the length of the single period Λ over which the optical axis rotates 180° in the liquid crystal alignment pattern gradually decreases from the center of the optically anisotropic layer 3 toward the outer direction of the one direction by reversing the direction in which the optical axis continuously rotates. The refraction angle of light with respect to an incidence direction increases as the length of the single period Λ in the liquid crystal alignment pattern decreases. Accordingly, the length of the single period Λ in the liquid crystal alignment pattern gradually decreases from the center of the optically anisotropic layer 3 toward the outer direction in the in-plane direction in which the optical axis continuously rotates. As a result, the light diverging power of the optically anisotropic layer 3 can be improved, and the performance as a concave lens can be improved.

For example, in a case where the optically anisotropic layer is used as a concave lens, it is also preferable that the turning direction of incident circularly polarized light is reversed.

Conversely, the length of the single period Λ in the concentric circular liquid crystal alignment pattern may gradually increase from the center of the optically anisotropic layer 3 toward the outer direction of the one direction in which the optical axis continuously rotates.

Furthermore, depending on the uses of the optically anisotropic layer such as a case where it is desired to provide a light amount distribution in the transmitted light, a configuration in which regions having partially different lengths of the single periods A in the one direction in which the optical axis continuously rotates are provided can also be used instead of the configuration in which the length of the single period Λ gradually changes in the one direction in which the optical axis continuously rotates.

Further, the light emitting element may include: an optically-anisotropic layer in which the single period Λ is homogeneous over the entire surface; and an optically-anisotropic layer in which regions having different lengths of the single periods A are provided.

In this way, the configuration of changing the length of the single period Λ over which the optical axis rotates 180° in the one direction in which the optical axis continuously rotates can also be used in the configuration shown in FIGS. 1 to 4 in which the optical axis 30A of the liquid crystal compound 30 changes while continuously rotating only in the one direction of the x direction.

For example, by gradually decreasing the single period Λ of the liquid crystal alignment pattern in the x direction, an optically anisotropic layer which transmits light so as to be gathered can be obtained. In addition, by reversing the direction over which the optical axis in the liquid crystal alignment pattern rotates 180°, an optically anisotropic layer which transmits light so as to be diffused only in the x direction can be obtained. By reversing the turning direction of incident circularly polarized light, an optically anisotropic layer that allows transmission of light to be diffused only in the arrow X direction can be obtained.

Furthermore, depending on the application of the optically anisotropic layer such as a case where it is desired to provide a light amount distribution in the transmitted light, a configuration in which regions having partially different lengths of the single periods A in the x direction are provided can also be used instead of the configuration in which the length of the single period Λ gradually changes in the x direction.

### [Optical Element]

An optical element according to an embodiment of the present invention includes the above-described optically anisotropic layer.

The application of the optical element is not particularly limited, but the optical element can be used for various uses where transmission of light in a direction different from an incidence direction is allowed, for example, an optical path changing member, a light collecting element, a light diffusing element to a predetermined direction, a diffraction element, or the like in an optical apparatus.

Among these, preferred examples of the application include a light guide element. The light guide element typically includes a light guide plate and a diffraction element that is disposed on the light guide plate (preferably, is disposed to be spaced from the light guide plate). The optical element according to the embodiment of the present invention is suitably used as a diffraction element.

The optical element may have a form including the optically anisotropic layer and an oxygen barrier layer disposed on at least one surface of the optically anisotropic layer.

By including the oxygen barrier layer, it is easier to further suppress the photodegradation of the tolan compound in the optically anisotropic layer, and the light resistance of the optical element is more excellent.

From the viewpoint of more excellent light resistance, among these, it is preferable that the optical element has an oxygen barrier layer on both surfaces of the optically anisotropic layer.

The oxygen permeability coefficient of the oxygen barrier layer at 25° C. and 50% RH is preferably 1.0×10⁻¹¹ cm³·cm/(cm²·s·mmHg) or less, and from the viewpoint of more excellent effect of the present invention, is more preferably 1.0×10⁻¹² cm³·cm/(cm²·s·mmHg) or less and still more preferably 1.0·×10⁻¹³ cm³·cm/(cm²·s·mmHg) or less. The lower limit value thereof is not particularly limited, but is, for example, preferably 1.0×10⁻²⁰ cm³·cm/(cm²·s·mmHg) or more.

The oxygen permeability coefficient of the oxygen barrier layer at 25° C. and 50% RH can be measured by an equal pressure method according to ISO 15105-2.

In addition, in the oxygen barrier layer, the value obtained by dividing the oxygen permeability coefficient [cm³·cm/(cm²·s·mmHg)] at 25° C. and 50% RH by the film thickness [μm] is preferably 1.0×10⁻¹¹ or less, more preferably 1.0×10⁻¹² or less, and still more preferably 1.0×10⁻¹³ or less. The lower limit value thereof is not particularly limited, but is preferably 1.0×10⁻²⁰ or more.

In addition, in the oxygen barrier layer, the transmittance is preferably 70% or more, more preferably 80% or more, and still more preferably 90% or more. The transmittance is intended to be an average transmittance of visible light having a wavelength of 400 to 700 nm.

The transmittance is a value measured at 25° C. using a spectrophotometer (for example, spectrophotometer UV-3100PC manufactured by Shimadzu Corporation).

Examples of a material constituting the oxygen barrier layer includes glass and a resin.

The resin constituting the oxygen barrier layer is not particularly limited, and examples thereof include an ethylene-vinyl alcohol copolymer, polyamide, polyvinyl alcohol, polyacrylonitrile, polyvinylidene chloride, and the like.

In addition, the organic molecular films described in JP2014-218444A and JP2014-218548A, the barrier films described in JP2020-188047A, the coating films described in JP2020-186281A, and the like can also be applied as the oxygen barrier layer.

In addition, the oxygen barrier layer may be a polarizing plate.

In addition, the oxygen barrier layer may contain an inorganic filler.

A lower limit of the thickness of the oxygen barrier layer is not particularly limited, but from the viewpoint of more excellent oxygen barrier properties, is preferably 0.01 μm or more, more preferably 0.1 μm or more, and still more preferably 1 μm or more. As the thickness of the oxygen barrier layer is increased, the oxygen barrier properties are enhanced. Therefore, the upper limit value of the thickness of the oxygen barrier layer is not particularly limited, but for example, in a case where the oxygen barrier layer is made of glass, from the viewpoint of making the thickness of the entire optical element thin and suppressing the weight, the upper limit value thereof is preferably 2 cm or less, more preferably 1 cm or less, and still more preferably 5 mm or less. In addition, for example, in a case where the oxygen barrier layer is a resin, from the viewpoint of making the thickness of the entire optical element thin and excellent productivity, the upper limit value thereof is preferably 2 cm or less, more preferably 1 cm or less, still more preferably 5 mm or less, even still more preferably 100 μm or less, particularly preferably 50 μm or less, particularly more preferably 30 μm or less, and most preferably 10 μm or less.

### EXAMPLES

Hereinafter, the present invention will be described in more detail with reference to Examples. The materials, the amount and ratio of the materials used, how to treat the materials, the treatment procedure, and the like shown in the following examples can be appropriately changed as long as the gist of the present invention is maintained. Accordingly, the scope of the present invention should not be construed as being limited to Examples shown below.

### Example 1

### [Production of Optical Element]

### <Support and Saponification Treatment of Support>

As a support, a commercially available triacetyl cellulose film “Z-TAC” (manufactured by Fujifilm Corporation) was used.

The support was allowed to pass through a dielectric heating roll at a temperature of 60° C. so that the surface temperature of the support was increased to 40° C.

Next, an alkali solution described below was applied onto a single surface of the support using a bar coater in a coating amount of 14 mL (liter)/m², the support was heated to 110° C., and the support was transported for 10 seconds under a steam-type far infrared heater (manufactured by Noritake Co., Ltd.).

Subsequently, 3 mL/m² of pure water was applied onto the surface of the support, onto which the alkali solution had been applied, using the same bar coater. Next, water cleaning using a foundry coater and water draining using an air knife were repeated three times, and then the support was transported and dried in a drying zone at 70° C. for 10 seconds, whereby the surface of the support was subjected to the alkali saponification treatment.

Alkaline solution

| | | |
|---|---|---|
| Potassium hydroxide | 4.70 | parts by mass |
| Water | 15.80 | parts by mass |
| Isopropyl alcohol | 63.70 | parts by mass |
| Surfactant SF-1: C₁₄H₂₉O(CH₂CH₂O)₂OH | 1.0 | part by mass |
| Propylene glycol | 14.8 | parts by mass |

### <Formation of Undercoat Layer>

The following coating liquid for forming an undercoat layer was continuously applied onto the surface of the support, which had been subjected to the alkali saponification treatment, using a #8 wire bar. The support on which the coating film had been formed was dried using hot air at 60° C. for 60 seconds and further dried using hot air at 100° C. for 120 seconds to form an undercoat layer.

Coating liquid for forming undercoat layer

| | |
|---|---|
| Modified polyvinyl alcohol V-1 | 2.40 parts by mass |
| Isopropyl alcohol | 1.60 parts by mass |
| Methanol | 36.00 parts by mass |
| Water | 60.00 parts by mass |

Modified polyvinyl alcohol V-1 (the ratios of repeating units in the following
structural formula are in terms of mass ratio)

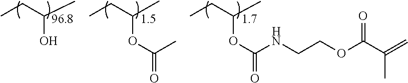

### <Formation of Alignment Film>

The following coating liquid for forming an alignment film was continuously applied onto the support, onto which the undercoat layer had been formed, using a #2 wire bar. The support on which the coating film of the coating liquid for forming an alignment film had been formed was dried using a hot plate at 60° C. for 60 seconds to form an alignment film.

Coating liquid for forming alignment film

| | |
|---|---|
| Material D for photo alignment | 1.00 part by mass |
| Water | 16.00 parts by mass |
| Butoxyethanol | 42.00 parts by mass |
| Propylene glycol monomethyl ether | 42.00 parts by mass |

Material D for photo alignment

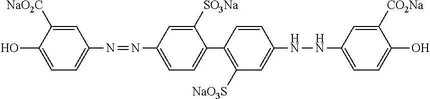

### <Exposure of Alignment Film>

An exposure film was exposed using the exposure device of FIG. 5 of WO2020/022496A to form an alignment film P-1 having an alignment pattern.

In the exposure device, a laser that emits a laser beam having a wavelength of 325 nm was used as the laser. The exposure amount of the interference light was 2,000 mJ/cm². It is noted that one period (the length over which the optical axis derived from the liquid crystal compound rotates) 180° of an alignment pattern formed by interference of two laser beams was controlled by changing the intersecting angle (the intersecting angle β) between the two beams.

### <Formation of Optically Anisotropic Layer>

As a composition forming the optically anisotropic layer, the following composition E-1 was prepared.

Composition E-1

| | |
|---|---|
| The following polymerizable liquid crystal compound L-1 | 90 parts by mass |
| The following polymerizable liquid crystal compound L-2 | 10 parts by mass |
| Antioxidant: DL-α-tocopherol (corresponding to tocopherols) | 5 parts by mass |
| Polymerization initiator (manufactured by BASF SE, IRGACURE (registered trademark) 819) | 3.00 parts by mass |
| The following leveling agent T-1 | 0.08 parts by mass |
| Methyl ethyl ketone | 927.7 parts by mass |

Polymerizable liquid crystal compound L-1 (corresponding to the liquid crystal compound A) 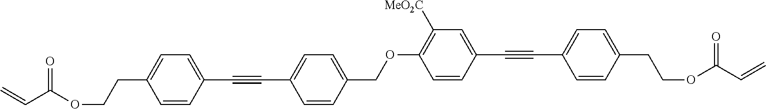 [SMILES: C=CC(=O)OCCc1ccc(C#Cc2ccc(COc3ccc(C#Cc4ccc(CCOC(=O)C=C)cc4)cc3C(=O)OC)cc2)cc1]
Polymerizable liquid crystal compound L-2 (corresponding to the liquid crystal compound B) 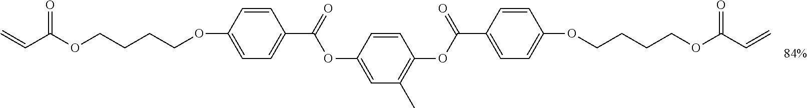 [SMILES: C=CC(=O)OCCCCOc1ccc(C(=O)Oc2ccc(OC(=O)c3ccc(OCCCCOC(=O)C=C)cc3)c(C)c2)cc1] 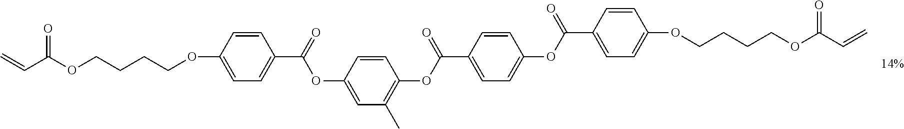 [SMILES: C=CC(=O)OCCCCOc1ccc(C(=O)Oc2ccc(C(=O)Oc3ccc(OC(=O)c4ccc(OCCCCOC(=O)C=C)cc4)cc3C)cc2)cc1] 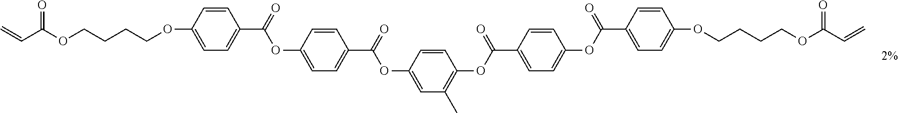 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]
Leveling agent T-1

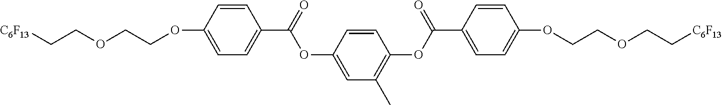

The optically anisotropic layer was formed by applying multiple layers of the composition E-1 to the alignment film P-1. The multilayer coating refers to repeating a procedure in which, first, the composition E-1 is applied for a first layer on an alignment film, heated, and cooled, followed by being cured with ultraviolet rays to produce a liquid crystal immobilized layer, and then, for a second layer and subsequent layers, this liquid crystal immobilized layer is subjected to multiple coating by the application of the composition E-1, heating, and cooling, followed by curing with ultraviolet rays in the same manner. Due to the formation by the multilayer coating, the alignment direction of the alignment film is reflected over the upper surface of the liquid crystal layer from the lower surface (the surface on the alignment film P-1 side) even in a case where the film thickness of the liquid crystal layer is increased.

First, the following composition E-1 was applied for the first liquid crystal layer onto the alignment film P-1 to form a coating film, the coating film was heated to 80° C. using a hot plate and then cooled to 80° C., followed by being irradiated with ultraviolet rays having a wavelength of 365 nm at an irradiation dose of 300 mJ/cm² using a high-pressure mercury lamp in a nitrogen atmosphere, whereby the alignment of the liquid crystal compound was fixed. At this time, the film thickness of the first liquid crystal layer was 0.3 μm.

For the second and subsequent liquid crystal layers, this liquid crystal layer was subjected to multiple coating, heating, and cooling under the same conditions as described above, followed by curing with ultraviolet rays to produce a liquid crystal immobilized layer (a cured layer). In this way, multiple coating was repeated until the in-plane retardation (Re) reached 325 nm, optically anisotropic layer H-1 was formed as an optical element G-1.

It was verified using a polarization microscope that the optically anisotropic layer according to the example had a periodically aligned surface as shown in FIG. 2 and FIG. 3, which is described above. In the liquid crystal alignment pattern of the optically anisotropic layer, the single period Λ over which the optical axis derived from the liquid crystal compound rotated by 180° was 1.0 μm. The period Λ was determined by measuring the period of the bright and dark pattern observed under the crossed nicol condition using a polarization microscope.

### Example 2

An optical element G-2 was produced according to the same procedure as in Example 1, except that, as the antioxidant used in Example 1, the following antioxidant Q-1 (corresponding to catechols) was used instead of tocopherol.

### Antioxidant Q-1

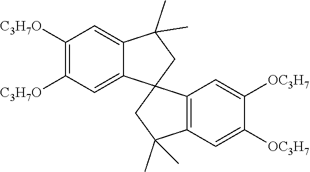

### Example 3

An optical element G-3 was produced according to the same procedure as in Example 1, except that, as the antioxidant used in Example 1, DABCO (1,4-diazabicyclo[2.2.2]octane) (corresponding to tertiary amines) was used instead of tocopherol.

### Example 4

An optical element G-4 was produced according to the same procedure as in Example 1, except that, as the antioxidant used in Example 1, Irganox 1035FF manufactured by BASF SE (corresponding to hindered phenols) was used instead of tocopherol.

### Example 5

An optical element G-5 was produced according to the same procedure as in Example 1, except that, as the antioxidant used in Example 1, Tinuvin 770DF manufactured by BASF SE (corresponding to hindered amines) was used instead of tocopherol.

### Example 6

An optical element G-6 was produced according to the same procedure as in Example 1, except that, as the antioxidant used in Example 1, the following antioxidant Q-2 (corresponding to hydroxylamines) was used instead of tocopherol.

### Antioxidant Q-2

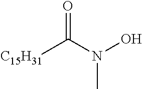

### Example 7

An optically anisotropic layer was produced by the same procedure as in Example 1, except that 100 parts by mass of the following polymerizable liquid crystal compound L-3 was used as the polymerizable liquid crystal compound, and 2 parts by mass of the above-described antioxidant Q-2 (corresponding to hydroxylamines) was used as the antioxidant. Subsequently, the optically anisotropic layer was subjected to plasma treatment, then a coating liquid O-1 for oxygen barrier layer having the following composition was prepared, spin-coated onto the optically anisotropic layer, and dried on a hot plate at 100° C. for 60 seconds to obtain an optical element G-7.

### Polymerizable Liquid Crystal Compound L-3 (Corresponding to the Liquid Crystal Compound A)

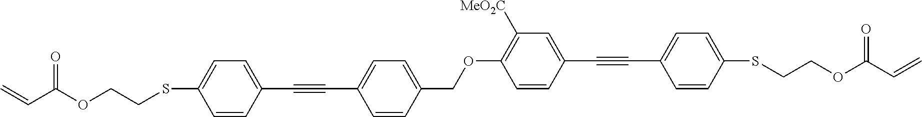 [SMILES: C=CC(=O)OCCSc1ccc(C#Cc2ccc(COc3ccc(C#Cc4ccc(SCCOC(=O)C=C)cc4)cc3C(=O)OC)cc2)cc1]

Coating liquid O-1 for oxygen barrier layer

| | | |
|---|---|---|
| Modified polyvinyl alcohol V-1 described above | 7.00 | parts by mass |
| Isopropyl alcohol | 21.00 | parts by mass |
| Water | 70.00 | parts by mass |
| Propylene glycol monomethyl ether acetate | 2.00 | parts by mass |

### Example 8

An optical element G-8 was produced according to the same procedure as in Example 7, except that 1 part by mass of Irganox PS800FL manufactured by BASF SE (corresponding to a sulfur-based antioxidant) was used instead of 2 parts by mass of the above-described antioxidant Q-2 used in Example 7.

### Example 9

An optical element G-9 was produced according to the same procedure as in Example 7, except that 0.5 parts by mass of Irganox 1035FF manufactured by BASF SE (corresponding to hindered phenols) was used instead of 2 parts by mass of the above-described antioxidant Q-2 used in Example 7.

### Example 10

An optical element G-10 was produced according to the same procedure as in Example 7, except that 1 part by mass of Tinuvin 770DF manufactured by BASF SE (corresponding to hindered amines) was used instead of 2 parts by mass of the above-described antioxidant Q-2 used in Example 7.

### Example 11

An optical element G-11 was produced according to the same procedure as in Example 7, except that 0.5 parts by mass of the above-described antioxidant Q-1 (corresponding to catechols) was used instead of 2 parts by mass of the above-described antioxidant Q-2 used in Example 7.

### Example 12

An optical element G-12 was produced according to the same procedure as in Example 7, except that 0.5 parts by mass of the following antioxidant Q-3 (corresponding to catechols) was used instead of 2 parts by mass of the above-described antioxidant Q-2 used in Example 7.

### Antioxidant Q-3

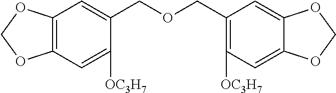

### Example 13

An optical element G-13 was produced according to the same procedure as in Example 7, except that 1 part by mass of the following antioxidant Q-4 (corresponding to hydroxylamines) was used instead of 2 parts by mass of the above-described antioxidant Q-2 used in Example 7.

### Antioxidant Q-4

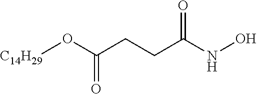

### Example 14

An optical element G-14 was produced according to the same procedure as in Example 7, except that 0.3 parts by mass of Irganox 1035FF manufactured by BASF SE (corresponding to hindered phenols) and 1 part by mass of the above-described antioxidant Q-2 (corresponding to hydroxylamines) were used instead of 2 parts by mass of the above-described antioxidant Q-2 used in Example 7.

### Comparative Example 1

An optical element G-15 was produced according to the same procedure as in Example 1, except that the antioxidant was not used.

### Comparative Example 2

An optical element G-16 was produced according to the same procedure as in Example 7, except that the antioxidant was not used.

### Comparative Example 3

An optical element G-17 was produced according to the same procedure as in Example 7, except that 0.5 parts by mass of the following antioxidant Q-5 (corresponding to hindered amines) was used instead of 1 part by mass of the above-described antioxidant Q-2 used in Example 7.

### Antioxidant Q-5

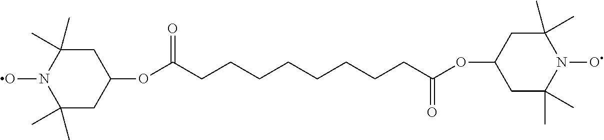

### [Calculation of Distance ΔHSP]

The distance ΔHSP value was obtained by the following procedure.

(1) First, using the commercially available software “HSPiP”, three vectors of Hansen solubility parameter (dispersion element component of Hansen solubility parameter vector: δD, polar element component of Hansen solubility parameter vector: δP, and hydrogen bonding element component of Hansen solubility parameter vector: δH) were obtained for each of the antioxidant, the compound A, and the liquid crystal compound B.

(2) In a case where the liquid crystalline composition contains both the compound A and the liquid crystal compound B, the average δDₓ of the compound A and the liquid crystal compound B was calculated according to the following expression.

$$Average δ {D}_{x} = δ {D}_{1} \times {W}_{1} + δ {D}_{2} \times {W}_{2} + … δ {D}_{n} \times {W}_{n}$$

Here, δDₙ represents SD of each compound corresponding to the compound A and the liquid crystal compound B, and Wₙ represents a content of each compound (mass fraction: content ratio of each compound with respect to the total content of each compound) described above.

For example, in a case where the optically anisotropic layer contains the compound A and the liquid crystal compound B in equal amount to each, the average δDₓ=δD₁×W₁+δD₂×W₂ (δD₁ and δD₂ each represent δD of the compound A and the liquid crystal compound B, and W₁ and W₂ represent 0.5).

(3) According to the same procedure as in (2), the average δPₓ and the average δHₓ of the compound A and the liquid crystal compound B were each calculated.

(4) The distance ΔHSP was derived according to the following expression.

$$Δ HSP value = {\{ 4 \times {( δ {D}_{A} - δ {D}_{B} )}^{2} + {( δ {P}_{A} - δ {P}_{B} )}^{2} + {( δ {H}_{A} - δ {H}_{B} )}^{2} \}}^{0.5}$$

Here, in a case where the liquid crystalline composition contains both the compound A and the liquid crystal compound B, δD_{A}, δP_{A}, and δH_{A} each represent an average δDₓ, an average δPₓ, and an average δHₓ of the compound A and the liquid crystal compound B. In a case where the liquid crystalline composition contains only the compound A and does not contain liquid crystal compound B, δD_{A}, δP_{A}, and δH_{A} each represent δD, δP, and δH of the compound A. In addition, δD_{B}, δP_{B}, and δH_{B} represent δD, δP, and δH of the antioxidant.

Next, the obtained results were classified based on the following evaluation standard. The results are shown in Table 1.

### <<Evaluation Standard>>

“A”: distance ΔHSP was 9.1 MPa^{0.5} or less.
“B”: distance ΔHSP was larger than 9.1 MPa^{0.5} and 10.5 MPa^{0.5} or less.
“C”: distance ΔHSP was larger than 10.5 MPa^{0.5}.

### [Refractive Index Anisotropy Δn of Each Liquid Crystal Composition]

In a case where the refractive index anisotropy Δn of the liquid crystalline composition used in the production of the optical element of Examples and Comparative Examples was measured by the following procedure, all of Δn at a wavelength of 550 nm were 0.21 or more.

### <<Measuring Method>>

The liquid crystalline composition was heated on a hot plate at 120° C. to remove the solvent, thereby producing a measurement sample. Next, the refractive index anisotropy Δn of each measurement sample was measured by a method using a wedge-shaped liquid crystal cell described on page 202 of “Liquid Crystal Handbook” (edited by Liquid Crystal Handbook Editing Committee, published by Maruzen Co., Ltd.). [Evaluation of oxygen barrier layer]

For the oxygen barrier layers of Examples 7 to 14, an oxygen permeability coefficient [cm³·cm/(cm²·s·mmHg)] was obtained by the following procedure, a value (oxygen permeability) calculated by dividing the obtained oxygen permeability coefficient [cm³·cm/(cm²·s·mmHg)] by the film thickness [μm] of the oxygen barrier layer was more than 1.0×10⁻¹³ and 1.0×10⁻¹² or less.

### [Measurement of Oxygen Permeability Coefficient of Oxygen Barrier Layer, and the Like]

The oxygen permeability coefficient of the oxygen barrier layer alone was measured by the following procedure.

An oxygen barrier layer was produced on the Z-TAC by repeating the operation of spin-coating the above-described coating liquid O-1 for an oxygen barrier layer onto a commercially available triacetyl cellulose film (manufactured by FUJIFILM Corporation, Z-TAC) and drying the coating film on a hot plate at 100° C. for 60 seconds, three times. Next, an oxygen permeability coefficient of the obtained Z-TAC with an oxygen barrier layer was determined by the following procedure. In addition, the oxygen permeability coefficient of the Z-TAC was obtained by the following procedure, and the oxygen permeability coefficient of the Z-TAC with an oxygen barrier layer was divided by the oxygen permeability coefficient of the Z-TAC to calculate the oxygen permeability coefficient of the oxygen barrier layer alone.

Test method: ISO 15105-2 (equal pressure method)

Tester: self-made oxygen permeability tester produced by partially modifying an oxygen concentration meter model 3600 manufactured by Hach Ultra Analytics, Inc. (weighing and calibration with an oxygen permeability tester OX-TRAN 2/10 type manufactured by AMETEK MOCON)
Test temperature: 25° C.
Test humidity: relative humidity of 50% RH
Test gas: air (oxygen content)

### [Evaluation of Pattern Aligning Properties]

The pattern alignment properties of the liquid crystal compound were evaluated using an optical microscope. Next, the obtained results were classified based on the following evaluation standard. The results are shown in Table 1.

### <<Evaluation Standard>>

“A”: no alignment defect
“B”: alignment defect was observed

### [Evaluation of Light Resistance]

### <Measurement of Diffraction Efficiency>

An evaluation optical system in which a light source for evaluation, a polarizer, a ¼ wavelength plate, any of the optical elements G-1 to G-17 (hereinafter, also referred to as “optical element G”), and a screen were arranged in this order was prepared. As the light source for evaluation, a laser pointer having a wavelength of 650 nm was used. As the ¼ wave plate, SAQWP05M-700 manufactured by Thorlabs, Inc. was used. The slow axis of the ¼ wavelength plate was arranged at a relationship of 45° with respect to the absorption axis of the polarizer. In addition, the optical element G was disposed with the triacetyl cellulose film surface facing the light source side.

As a result of causing the light transmitted from the light source for evaluation through the polarizer and the ¼ wavelength plate, to be incident on the optical element G with being perpendicular to the film surface, a part of the light transmitted through the optical element was diffracted, and a plurality of bright spots could be confirmed on the screen.

The intensity of the diffracted light corresponding to each of the bright spots on the screen and the intensity of the zero-order light w measured with a power meter, and the diffraction efficiency was calculated according to the following expression.

Diffraction efficiency=(intensity of first-order light)/(intensity of zero-order light+intensity of diffracted light other than first-order light)

### <Evaluation of Light Resistance>

The produced optical element was irradiated with light using a super xenon weather meter SX75 manufactured by Suga Test Instruments Co., Ltd. As the UV cut filter, an ultraviolet absorbing filter SC-40 manufactured by FUJIFILM Corporation was used, and a light resistance test was performed by irradiating the filter with 5,000,000 l× of light for 72 hours. The temperature of the specimen to be tested (the temperature inside the test device) was set to 63° C. The relative humidity in the test device was 50% RH.

Next, the diffraction efficiency of the optical element after the light resistance test was measured, and the reduction amount in diffraction efficiency of the optical element before and after the light resistance test was obtained.

The evaluation of the reduction amount in diffraction efficiency was performed based on a value standardized by the following expression.

In the evaluation of Examples 1 to 6 and Comparative Example 1, Comparative Example 1 was used as a reference comparative example, and each standardization reduction amount of each of Examples and Comparative Examples was obtained by the following expression.

In addition, in the evaluation of Examples 7 to 14 and Comparative Example 2, Comparative Example 2 was used as a reference comparative example, and each standardized reduction amount of each of Examples and Comparative Examples was obtained by the following expression. The evaluation standard is as follows, and the lower the standardized reduction amount is, the more excellent the light resistance is. The results are shown in Table 1.

(standardized reduction amount)=(reduction amount in diffraction efficiency of each optical element of each of Examples and Comparative Examples)/(reduction amount in diffraction efficiency of optical element of reference comparative example)

### <<Evaluation Standard>>

“A”: standardized reduction amount was less than 0.45.
“B”: standardized reduction amount was 0.45 or more and less than 0.60.
“C”: standardized reduction amount was 0.60 or more and less than 0.95.
“D”: standardized reduction amount was 0.95 or more and 1.00 or less.

Table 1 is shown below.

In Table 1, the column of “Remarks” in the column of “Antioxidant” indicates the type of the antioxidant, in which “A” indicates a case where the antioxidant corresponds to any selected from the group consisting of hydroxylamines, hindered phenols, and hindered amines, and “B” indicates a case where the antioxidant does not correspond to any of them.

In Table 1, in the column of “presence or absence of oxygen barrier layer”, “absent” means a case where the oxygen barrier layer is absent, and “present” means a case where the oxygen barrier layer is present.

In Table 1, “-” in the column of “Light resistance” in Comparative Example 3 indicates that the measurement was not performed.

TABLE 1

| | | | | | | Presence or | | |
|---|---|---|---|---|---|---|---|---|
| | | | Antioxidant | | | absence of | Evaluation result | |
| | Type of | Liquid crystal | Type | | | oxygen | Pattern | |
| | optical | compound | Compound | | Distance | barrier | aligning | Light |
| | element | (mass ratio) | name | Remarks | ΔHSP | layer | properties | resistance |
| Comparative | G-15 | L-1/L-2 = 9/1 | — | — | — | Absence | A | D |
| Example 1 | | | | | | | | |
| Example 1 | G-1 | L-1/L-2 = 9/1 | DL-α-tocopherol | B | A | Absence | A | C |
| Example 2 | G-2 | L-1/L-2 = 9/1 | Q-1 | B | A | Absence | A | C |
| Example 3 | G-3 | L-1/L-2 = 9/1 | DABCO | B | A | Absence | A | C |
| Example 4 | G-4 | L-1/L-2 = 9/1 | Irganox 1035FF | A | A | Absence | A | A |
| Example 5 | G-5 | L-1/L-2 = 9/1 | Tinuvin 770DF | A | A | Absence | A | A |
| Example 6 | G-6 | L-1/L-2 = 9/1 | Q-2 | A | A | Absence | A | A |
| Comparative | G-16 | L-3 | — | — | — | Presence | A | D |
| Example 2 | | | | | | | | |
| Example 7 | G-7 | L-3 | Q-2 | A | A | Presence | A | A |
| Example 8 | G-8 | L-3 | Irganox PS800FL | B | B | Presence | A | C |
| Example 9 | G-9 | L-3 | Irganox 1035FF | A | A | Presence | A | A |
| Example 10 | G-10 | L-3 | Tinuvin 770DF | A | A | Presence | A | A |
| Example 11 | G-11 | L-3 | Q-1 | B | A | Presence | A | B |
| Example 12 | G-12 | L-3 | Q-3 | B | A | Presence | A | B |
| Example 13 | G-13 | L-3 | Q-4 | A | B | Presence | A | C |
| Example 14 | G-14 | L-3 | Q-2 | A | A | Presence | A | A |
| | | | Irganox 1035FF | A | A | | | |
| Comparative | G-17 | L-3 | Q-5 | A | C | Presence | B | — |
| Example 3 | | | | | | | | |

From the results in Table 1, it was found that the optical element including the film formed of the liquid crystalline composition of Examples had excellent light resistance and also had excellent aligning properties of the liquid crystal compound.

In addition, from the comparison of the examples, it was confirmed that, in a case where the distance ΔHSP value of the liquid crystalline composition was 9.1 MPa^{0.5} or less (preferably, the distance ΔHSP value was 9.1 MPa^{0.5} or less and the antioxidant included any one or more selected from the group consisting of hydroxylamines, hindered phenols, or hindered amines), the optical element including the film formed of the liquid crystalline composition had more excellent light resistance.

### EXPLANATION OF REFERENCES

1, 2, 3: optically anisotropic layer
xy plane: sheet surface
z direction: thickness direction
30: liquid crystal compound
A: length of single period
30A: optical axis derived from liquid crystal compound 30
θ: angle
R: region
d: thickness (film thickness) of optically anisotropic layer
P_{L}: levorotatory circularly polarized light
P_{R}: dextrorotatory circularly polarized light
L₁, L₄, L₆: incidence light
L₂, L₅, L₇: transmitted light
Q1, Q2: absolute phase
E1, E2: equiphase surface
A₁, A₂, A₃: direction

What is claimed is:

1. A liquid crystalline composition comprising:
a compound A having a partial structure represented by Formula (I); and
an antioxidant,
wherein, in a case where the compound A exhibits liquid crystallinity and the composition does not contain a liquid crystal compound B having a structure different from a structure of the compound A, a distance ΔHSP between a Hansen solubility parameter of the antioxidant and a Hansen solubility parameter of the compound A is 10.5 MPa^{0.5} or less, and
in a case where the composition contains the liquid crystal compound B, a distance ΔHSP between the Hansen solubility parameter of the antioxidant, and an average Hansen solubility parameter of the Hansen solubility parameter of the compound A and a Hansen solubility parameter of the liquid crystal compound B is 10.5 MPa^{0.5} or less, 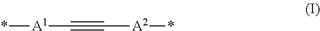
in Formula (I), A¹ and A² each independently represent an aromatic hydrocarbon ring group or an aromatic heterocyclic group, which may have a substituent, and * represents a bonding position.

2. The liquid crystalline composition according to claim 1,
wherein the compound A exhibits liquid crystallinity.

3. The liquid crystalline composition according to claim 1,
wherein the compound A is a polymerizable liquid crystal compound.

4. The liquid crystalline composition according to claim 1,
wherein the compound A is a compound represented by Formula (II), 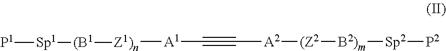
in Formula (II),
P¹ and P² each independently represent a hydrogen atom, a halogen atom, —CN, —NCS, or a polymerizable group,
Sp¹ and Sp² each independently represent a single bond or a divalent linking group, provided that Sp¹ and Sp² do not represent a divalent linking group including at least one group selected from the group consisting of an aromatic hydrocarbon ring group, an aromatic heterocyclic group, and an aliphatic hydrocarbon ring group,
Z¹ and Z² each independently represent a single bond or a divalent linking group, in a case where there are a plurality of Z¹'s and a plurality of Z²'s, the plurality of Z¹'s may be the same as or different from each other and the plurality of Z²'s may be the same as or different from each other, provided that Z¹ and Z² do not represent a divalent linking group including at least one group selected from the group consisting of an aromatic hydrocarbon group, an aromatic heterocyclic ring group, and an aliphatic hydrocarbon ring group,
A¹ and A² each independently represent an aromatic hydrocarbon ring group or an aromatic heterocyclic group, which may have a substituent,
B¹ and B² each independently represent an aromatic hydrocarbon ring group, an aromatic heterocyclic group, or an aliphatic hydrocarbon ring group, which may have a substituent, and in a case where there are a plurality of B¹'s and a plurality of B²'s, the plurality of B¹'s may be the same as or different from each other and the plurality of B²'s may be the same as or different from each other, and
n and m each independently represent an integer in a range of 0 to 4.

5. The liquid crystalline composition according to claim 4,
wherein, in Formula (II), at least one of P¹ or P² is a polymerizable group.

6. The liquid crystalline composition according to claim 1,
wherein the compound A is a compound represented by Formula (III) or (IV), 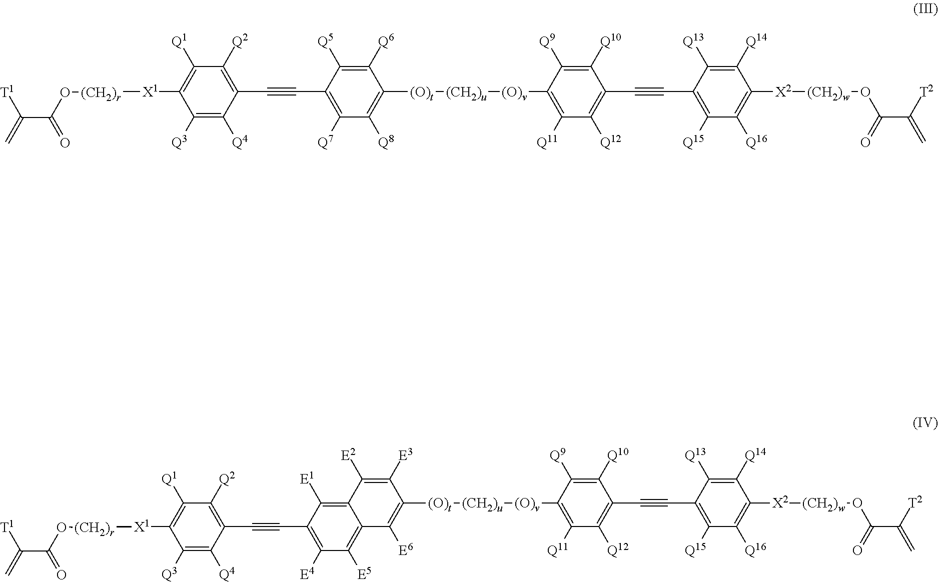
in Formulae (III) and (IV),
T¹ and T² each independently represent a hydrogen atom or a methyl group,
X¹ and X² each independently represent a methylene group, an oxygen atom, or a sulfur atom,
r represents an integer in a range of 1 to 5,
t and v each independently represent 0 or 1,
u represents 1 or 2,
w represents an integer in a range of 1 to 5,
Q¹ to Q¹⁶ each independently represent a hydrogen atom or a substituent, and
E¹ to E⁶ each independently represent a hydrogen atom or a substituent.

7. The liquid crystalline composition according to claim 1,
wherein at least one of the liquid crystal compounds B is a polymerizable liquid crystal compound.

8. The liquid crystalline composition according to claim 1,
wherein, in a case where the composition contains the liquid crystal compound B, a content of the compound A is 50% by mass or more with respect to a total content of the compound A and the liquid crystal compound B.

9. The liquid crystalline composition according to claim 1,
wherein Δn of the composition at a wavelength of 550 nm is 0.21 or more.

10. The liquid crystalline composition according to claim 1,
wherein, in a case where the compound A exhibits liquid crystallinity and the composition does not contain the liquid crystal compound B, a content of the antioxidant is 0.01% to 5% by mass with respect to a content of the compound A, and
in a case where the composition contains the liquid crystal compound B, a content of the antioxidant is 0.01% to 5% by mass with respect to a total content of the compound A and the liquid crystal compound B.

11. The liquid crystalline composition according to claim 1,
wherein the antioxidant includes one or more selected from the group consisting of tertiary amines, hydroxylamines, tocopherols, catechol ethers, hindered phenols, and hindered amines.

12. The liquid crystalline composition according to claim 1,
wherein the antioxidant includes one or more selected from the group consisting of hydroxylamines, hindered phenols, and hindered amines.

13. The liquid crystalline composition according to claim 1,
wherein the antioxidant includes hydroxylamines.

14. The liquid crystalline composition according to claim 13,
wherein the hydroxylamines are a compound represented by Formula (V), 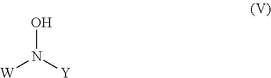
in Formula (V), W represents a hydrogen atom or a methyl group, and Y represents a linear or branched alkyl group having 1 to 30 carbon atoms, in which one or more —CH₂—'s may be substituted with a group selected from the group consisting of —O—, —NH—, and —CO—.

15. The liquid crystalline composition according to claim 1, further comprising:
a polymerization initiator.

16. The liquid crystalline composition according to claim 1, further comprising:
a chiral agent.

17. An optically anisotropic layer consisting of the cured product obtained by curing the liquid crystal compound according to claim 1.

18. The optically anisotropic layer according to claim 17,
wherein the optically anisotropic layer has an alignment pattern, and
the alignment pattern is an alignment pattern in which an orientation of an optical axis derived from a liquid crystal compound contained in the composition is changed while continuously rotating along at least one in-plane direction.

19. An optical element comprising:
the optically anisotropic layer according to claim 18.

20. A light guide element comprising:
the optical element according to claim 19; and
a light guide plate.
